(19) United States
(12) Patent Application Publication
(10) Pub. No.: US 2008/0177518 A1
(43) Pub. Date: Jul. 24, 2008

(54) Integrated Microfluidic System Design Using Mixed Methodology Simulations

(75) Inventors: Sivaramakrishnan Krishnamoorthy, Madison, AL (US); Aditya Bedekar, Huntsville, AL (US); Sachin Siddhaye, Huntsville, AL (US); Yi Wang, Madison, AL (US); Shivshankar Sundaram, Madison, AL (US)

Correspondence Address: TOMAS FRIEND, LLC, 904 BOB WALLACE AVENUE, SUITE 228, HUNTSVILLE, AL, 35801, US

(73) Assignee: CFD Research Corporation

(21) Appl. No.: 11/624,589

(22) Filed: Jan. 18, 2007

(51) Int. Cl. G06F 17/50

(52) U.S. Cl. 703/9

(57) ABSTRACT

The present invention is a simulation-based method for rapidly designing, evaluating, and/or optimizing a microfluidic system or biochip. The method provides an environment for schematic generation, system layout, problem setup, simulation, and post-processing. The method comprises a system solver used to simulate microfluidic processes such as pressure driven and electroosmotic flows, analytes dispersion, separation, and mixing, and biochemical reactions. The system solver uses a mixed methodology approach that enables the operation of complete, complex microfluidic systems to be simulated rapidly and iteratively.

### CROSS-REFERENCE TO RELATED APPLICATIONS

Not Applicable

### STATEMENT REGARDING FEDERALLY SPONSORED RESEARCH OR DEVELOPMENT

The U.S. Government may have certain rights in this invention pursuant to NASA Contract No NNC04CA05C.

### INCORPRATED-BY-REFERENCE OF MATERIAL SUBMITTED ON A COMPACT DISC

Not Applicable

### BACKGROUND OF THE INVENTION

1. Field of the Invention

The present invention is a simulation-based method for rapidly designing, evaluating, and/or optimizing a microfluidic system or biochip. The method provides a software environment for schematic generation, system layout, problem setup, simulation, and post-processing. The software also comprises a system solver to simulate microfluidic processes such as pressure driven and electroosmotic flows, electrophoretic separation, analyte dispersion, mixing of two or more analytic, heat transfer, electric and magnetic fields, and biochemical reactions. The solver uses a Mixed Methodology Approach for simulation that enables the operation of complete, complex microfluidic systems to be simulated rapidly and iteratively.

2. Description of Related Art

Integrated microfluidic systems such as those found in biomicrosystems are remarkably intricate, featuring complex interacting physical, biological, and chemical phenomena. Consequently, microfluidic systems designed using experiments alone are costly delays and prone to failure. A number of 3-D multiphysics modeling software packages such as Fluent® (Fluent Inc.), CFD-ACE+® (ESI Group), FEMLAB® (COMSOL Inc.) and CoventorWare® (Coventor Inc.) are available to simulate microfluidic processes. These software packages accurately simulate the operations of microfluidic system components. Simulations of complete microfluidic systems using these packages are, however, not practical because they use numerical methods that, are computationally intensive and time-consuming.

Although 3-D multiphysics simulations of components have been used in microfluidic system product development, these simulations do not scale efficiently for complex designs and are generally inadequate for system-level design. Their corresponding software packages also require a user to possess some background in computational analysis, which is a serious limitation considering that chemists and biologists, who do not generally have this background, dominate the lab-on-a-chip industry. There is a need for a microfluidic system level design tool that rapidly simulates complex phenomena, that, does not significantly compromise the accuracy of high-fidelity, 3-D simulations.

Part of this need has been met by electrical circuit simulation software packages for rapid system level simulation of microfluidic systems. These electrical circuit simulation packages use an analogy between How of liquids and electric current to simulate electroosmotic and pressure-driven flows. Unfortunately, convective-diffusive analyte transport under the action of electric field and/or pressure gradients is significantly more complex and cannot be modeled in this way. Modeling of microfluidic chips at the system level poses considerable challenges that have not been met until the present invention.

The present invention uses computational modeling software that includes a system solver that integrates diverse models to simulate various functions of microfluidic devices. This Mixed Methodology modeling approach uses two or more of the following modeling approaches to simulate physical processes that occur in a microfluidic component or subsystem or a system as a whole:
An analytical model using an integral formulation of the governing equations to simulate flow, thermal, or electric fields,
An analytical model based on method of moments to simulate electrophoretic transport and dispersion,
An analytical model based on Fourier decomposition to simulate mixing,
A two-compartment, modeling technique to simulate surface reactions,
A reduced order model based on numerical simulation to simulate volumetric reactions,
A reduced order model based on numerical simulation of an Ordinary Differential Equation (ODE) to simulate liquid filling process, and
A numerical model based on artificial, neural networks to characterize component and system functionality.

All governing equations are solved on a network representation of all or a part of the complete microfluidic system. Parametric results of simulations using Mixed Methodology modeling are within 10% of those derived from full 3-D simulations, but are achieved in 1% of the computational time or less

### BRIEF SUMMARY OF THE INVENTION

In one embodiment, the present invention is a computational method of for simulating the operation of a microfluidic system comprising two or more of:
Analytical models using integral formulations of the governing equations to simulate flow fields, thermal fields, or electrical fields,
An analytical model based on method of moments to simulate electrophoretic transport and dispersion of analytes,
An analytical model based on Fourier decomposition coupled with a numerical model to simulate mixing of two or more analytes,
A two-compartment modeling technique to simulate surface reactions,
A numerical model based on Method of Lines to simulate volumetric reactions, and
A numerical model based on solving an Ordinary Differential Equation (ODE) to simulate liquid filling process.

In a second embodiment, the present invention is a computational method of for simulating the operation of a microfluidic system comprising two or more of:
solving fluid flow using integrated forms of governing equations,
solving analyte mixing using a Fourier series model,
solving dispersion using a method of moments model,
solving a surface reaction or interaction parameter using a two compartment model, and
solving a volumetric reaction or interaction parameter using a method of lines model.

In a third embodiment, the present invention is a computational method of for simulating the operation of a microfluidic system device comprising the method steps of:
constructing a computerized layout corresponding to the microfluidic system device,
providing input, parameters and constraints for the operation of the device, and
calculating output parameters for the operation of the device using the computerized layout, input parameters, constraints, and a Mixed Methodology model.

In a fourth embodiment, the present invention is a computational method for rapid optimization of a microfluidic system device comprising:
specifying target input and output parameters for the operation of the device;
constructing an initial computerized layout corresponding to an initial device;
providing input parameters for the operation of the device to a solver comprising:
   a combination of compact models to calculate fluid flow, thermal field, electrical field, analyte dispersion and mixing, and surface reaction analyte concentrations and
   a method of lines based numerical model to calculate volumetric reaction analyte concentrations and liquid filling;
calculating output parameters for the operation of the initial device;
comparing the calculated output, parameters for the operation of the initial device with the target output parameters for the device:
modifying the initial computerized layout to generate a modified layout corresponding to a modified device;
providing input parameters for the operation of the modified device to a solver comprising:
   a combination of compact, models to calculate fluid flow, thermal field, electrical field, analyte dispersion and mixing, and surface reaction analyte concentrations and
   a method of lines based numerical model to calculate volumetric reaction analyte concentrations and liquid filling
computationally calculating output parameters for the operation of the modified device; and
repeating modification, calculation, and comparison procedures until the output parameters for the modified device meet or exceed the target output parameters for the operation of the microfluidic system device.

Other embodiments of the invention may apply computational models to different sets of physical phenomena. For example, analyte dispersion may be simulated using a model other than a method of moments model or a two caompartment model may be used to model a phenomenon other than surface reactions.

### BRIEF DESCRIPTION OF THE SEVERAL VIEWS OF THE DRAWINGS

FIG. 1 illustration the general concept of one embodiment of the invention

FIG. 2 outlines the architecture of PHAROS software.

FIG. 3 shows representative examples of standard microfluidic components.

FIG. 4 A and B illustrates the use of the PHAROS component library and layout editor.

FIG. 5 illustrates the coordinate system and geometry parameters used in a constant Radius bend.

FIG. 6 is a schematic of an element model for a Y-merging Junction.

FIG. 7 is a sketch of a two-compartment model for a reversible binding reaction.

FIG. 8 A and B shows the design and corresponding network representation of a separation biochip.

FIG. 9 compares the results of simulations for pressure-driven and electroosmotic flows using a 3-D numerical model and a compact model of the present invention.

FIG. 10 shows an electropherogram comparing analyte dispersion simulation results from a 3-D numerical model to results using a method of moments based analytical model.

FIG. 11 shows a simplified geometry used to validate the analytical model for combined flows.

FIG. 12 shows the effect of transit time on the variance of an analyte band as it moves through a microchannel network.

FIG. 13 compares system-level simulation results with experimental data on the concentration profile of resonifin.

FIG. 14 compares system simulated kinetic analysis of acerazolamide binding to surface-immobilized Anhydrase-II with BIACORE data.

FIG. 15 illustrates a microfluidic electrophoresis network layout creation in PHAROS.

FIG. 16 compares electric field dependent theoretical plate number predicted by simulation to that observed experimentally for an electrophoretic separations chip.

FIG. 17 shows an electrophoretic chip used for simulation of analyte dispersion.

FIG. 18 shows an electropherogram of analytics from a sample simulation of air electrophoretic chip.

FIG. 19 is an example of an optimization process that, can be implemented in PHAROS.

FIG. 20 A and B shows an initial design and corresponding layout of a passive micromixer.

FIG. 21 A and B are graphs of analyte concentration profiles along the channel cross-section of a passive micromixer.

FIG. 22 A and B are graphs of analyte concentration profiles along the channel cross-section of a passive micromixer.

FIG. 23 is a PHAROS network representation of an RNA isolation chip.

FIG. 24 A is a PHAROS screen shot showing the system layout and system pressure drop curve for a RNA isolation chip.

FIG. 24 B shows results from a system simulation illustrating the effects of flow sates on the extent of mixing between HL-60 cells and lysis buffer in the lysis chamber of a RNA isolation chip.

FIG. 25 is a schematic showing system elements and interactions for one embodiment of a PHAROS unified design environment for Mixed Methodology modeling.

FIG. 26 A and 8 a blood oxygen sensor design modeling techniques associated with each components during full system simulation.

FIG. 27 is a schematic of a Y-Junction modeled using an ANN, with input and output, parameters identified.

FIG. 28 presents a comparison of pressure drop across a Y-junction between multiphysics simulation and a trained ANN model.

FIG. 29 presents a comparison of average oxygen concentration at the exit of a Y-junction between multiphysics simulation and a trained ANN model.

FIG. 30 compares variance in oxygen concentration profile at the exit of a Y-junction using multiphysics simulation and a trained ANN model.

FIG. 31 A and B show the effect of flow rate on system performance and a schematic representation of design optimization parameters for a micromixer.

FIG. 32 illustrates the use of multiple ANN models to characterize fluidics and bioanalyte transport in a microfluidic component.

### DETAILED DESCRIPTION OF THE INVENTION

Definitions:

An “analytical model” is a model derived directly from the underlying physics of the process being modeled without grid discretization or numerical computation in the components. Analytical models facilitate short computing times but not all microfluidic components or phenomena are amenable to analytical models.

The term “compact model” refers to a set of ordinary differential or algebraic equations that describe properties of the system such as flow and analyte concentration. Examples of compact models include analytical models and reduced-order models.

A “governing equation” is a mathematical equation used to describe physical or chemical phenomenon. Governing equations describing individual phenomena may be combined to form a set of governing equations that, is used to describe combined phenomena.

“Method of lines” refers to a technique that uses semi-discretized physical governing equations to form a set of ordinary differential equations.

“Method of moments” refers to an analytical approach to model transient analyte transport. This approach transforms the governing convection-diffusion equation for transient analyte transport

into a series of homogeneous/inhomogeneous partial differential equations. These equations can be analytically solved to attain simple algebraic equations that evaluate the moments of various order of the analyte concentration Specifically, the zeroth-order moment predicts the distribution of the analyte mass in microfluidic channels; the first-order moment can be used to determine the centroid locations of the analyte; and the second-order moment can be used to evaluate the variance of the analyte band (square of the stand-deviation of the average analyte concentration).

The term mixed methodology modeling refers to a model in which two or more compact models are integrated with, each other or a model in which a compact model is integrated with a numerical model to simulate the operation of a microfluidic system or component.

A “numerical model” is a model in which the modeling domains and physics are directly discretized and numerically solved without approximation or order reduction. Numerical models have high, accuracy but long computing times for simulation.

A “reduced order model” is a model approximated and extracted from numerical discretization and computation. In a reduced order model, the order of the system is greatly reduced (e.g., through two-compartment approach), while the system characteristics for efficient and accurate design are maintained.

The term “two compartment model” refers to a modeling approach that divides the modeling domain into two compartments. In each compartment, properties are assumed to be spatially uniform but vary with time. Two compartment models employ an approximation of spatial independence of properties.

The term “volumetric reaction” is used to refer to a reaction that occurs in an entire volumetric domain that is occupied by one or more reactants, or analytes. The term “reaction” in this context includes a chemical reaction or non-covalent binding between two molecules.

The term “surface reaction” is used to refer to a reaction that occurs only on the boundary of a volumetric domain. The term “reaction” in this context includes a chemical reaction or non-covalent binding between two molecules.

A software package developed by the inventors called PHAROS is used to illustrate and describe the present invention. Other software packages capable, of solving governing equations and providing other required functions such as layout generation performed by PHAROS may also be used. The present invention is not limited to the use of PHAROS software specifically

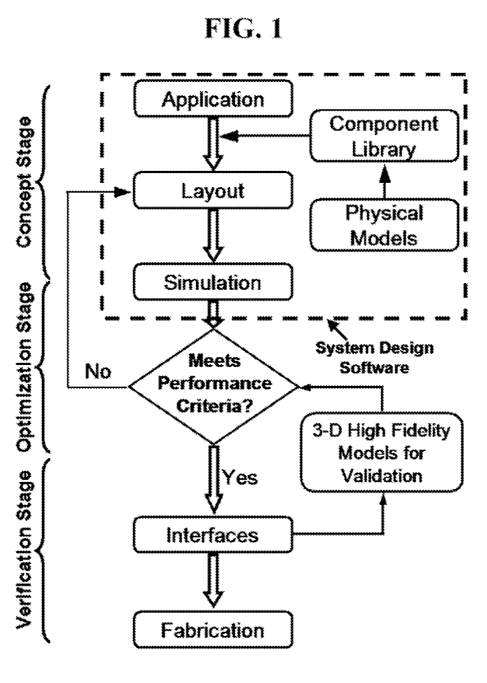

The present invention is a simulation-based method for rapidly designing and optimizing a microfluidic system or biochip. The method may be integrated with fabrication methods though AutoCAD output files generated by the underlying software. A pictorial illustration of the general concept, is shown in FIG. 1. The process uses computational simulations to generate optimized microsystem designs. The designs may then be exported in format files that link, directly to a fabrication device for physical prototyping.

PHAROS is used to create a layout for an initial microsystem design. PHAROS then simulates the operation of the initial design using input parameters provided by the user or defaults generated by the software and predicts the performance of the initial design. Based on the results of the simulation, the microsystem design is modified by PHAROS and the operation of the modified system is simulated. This optimization process is repeated until the predicted performance for a design meets desired or acceptable performance criteria, usually provided by the user. The optimized design may then be exported in a suitable format directly to a microfabrication device, which produces a prototype corresponding to the optimized design.

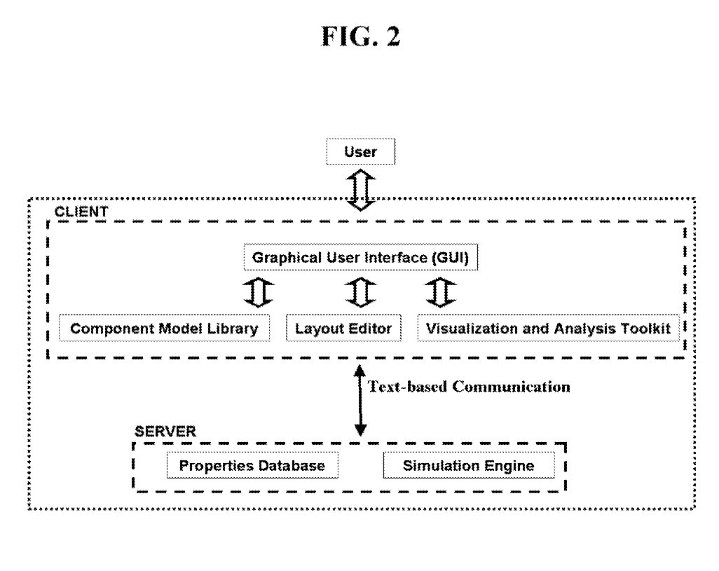

The architecture of PHAROS software is shown in FIG. 2 A user interacts with the Graphical User Interface (GUI)-based front-end, or client, which communicates with the server component. The client comprises three modules: the Component Model Library, Layout Editor and Visualization and Analysis Toolkit. The server comprises a properties database and a simulation engine.

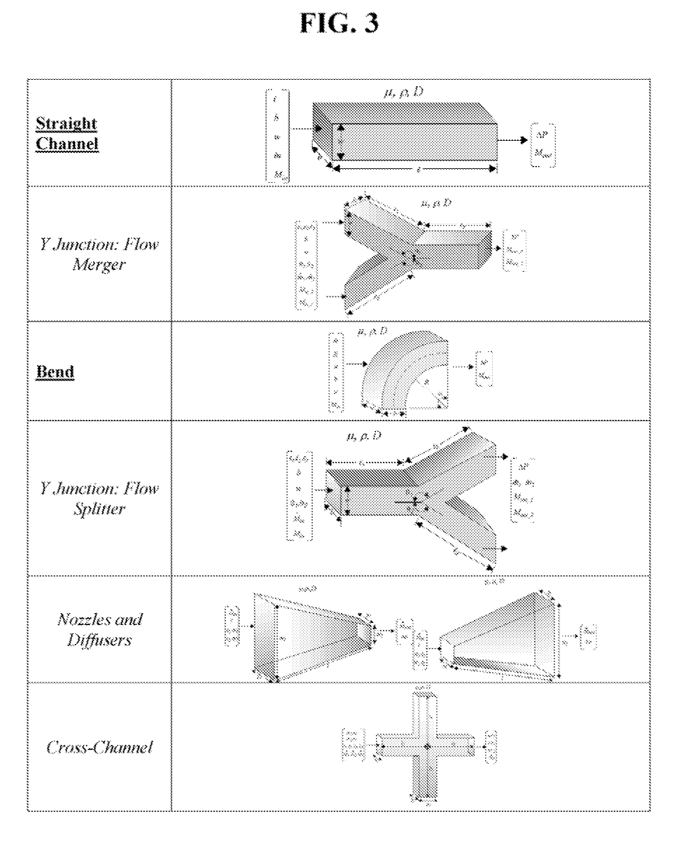

A. microfluidic chip typically comprises of a network of interconnected components, with each component performing a unique function, such as valving, pumping, sample purification, concentration, and detection. PHAROS includes a microfluidic component library of components, which have been characterized using physical models. Components are selected, dropped into a layout editor and assembled to create a microfluidic network; representing a microfluidic system. The Component Library comprises standard components (channel, bends, mixer, reaction chamber, electrodes, reagent wells, waste wells, cross channel, injector, detector, etc) and user defined networks (combination of standard components) or components (black boxes with known resistances) Representative examples of standard components are shown in FIG. 3.

The Layout Editor is used to set up a simulation problem for submission to the Simulation Engine. The desired components of a microfluidic network are assembled and all required properties are specified. These properties include length, width, and shape for a channel (geometric properties), density and viscosity of the buffer (physical properties), electrical conductivity, and electorphoretic mobility for an analyte. The Layout Editor also generates and displays components based on geometric input such as a bend with a given width, pitch, angle of bend. Visual feedback provides a real-estate footprint of the component on the screen and helps set up setup of the problem accurately by providing an intuitive way to assemble a network. The user is free to switch between tasks and does not have, to follow a rigid protocol.

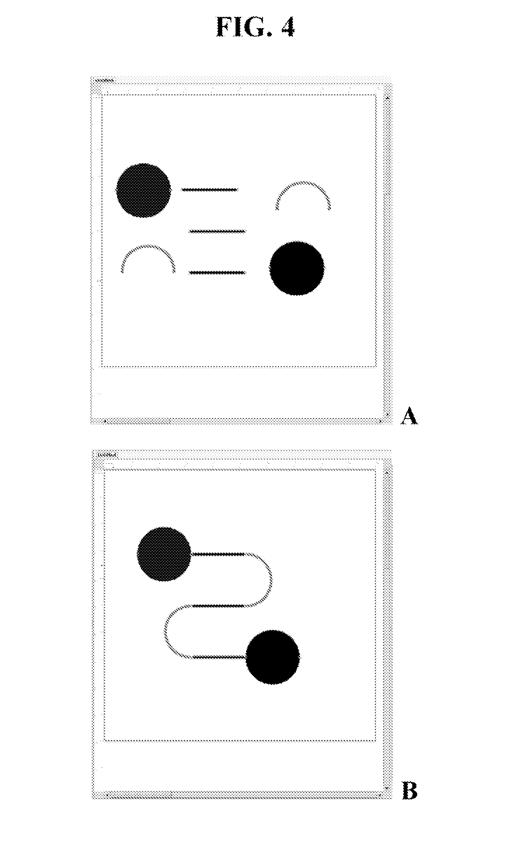

FIG. 4A shows a number of components dragged from the Component Library and dropped on the Layout Editor. The curved channels are rotated and the components are attached to each other to create the desired network shown in FIG. 4B. Each of the components in the network has a pre-determined set of properties associated with it, which are specified to obtain accurate modeling results.

After the candidate design has been assembled and the problem is completely specified, it is submitted to the Simulation Engine. The Simulation Engine typically takes seconds to a few minutes to return the results, depending on the type of problem solved. Then, the user visualizes and analyzes the results using the Visualization and Analysis Toolkit.

The Visualization and Analysis Toolkit provides the ability to load the results of a simulation for post processing and is seamlessly integrated with the rest of the GUI. The simulation output is viewed in tabular and multiple-series line chart formats. The toolkit is also used to filter tabular data, such that output for only selected components is displayed. For example, a complex chip layout with hundreds of components and several biosensors is much easier to analyze by visual identification of components rather than trying to remember the label associated with each of them. The user also uses the Toolkit to perform parametric studies by running multiple simulations and plotting the changes in a property across those simulations.

The server component comprises two modules: the Properties Database and the Simulation Engine. The Properties Database is an XML file that stores various physicochemical, electrical, biological and other properties for a variety of buffer media, analytes, and chip substrates. It has the ability to add new materials to the database and choose from among a variety of units. The Simulation Engine consists of the numerical solvers needed to run the simulation. It has been implemented in an object-oriented manner in C++ and is launched as a separate process by the GUI when the user hits the ‘run’ button The engine writes out the simulation output to a text file, which is then read by the GUI and displayed in a tabular format by the Visualization and Analysis toolkit. This data is also available to be plotted in multiple-series line charts.

PHAROS incorporates 3-D simulation models and a combination of compact models called Mixed Methodology modeling as needed to simulate the operation of each microfluidic system. The use of Mixed Methodology models reduces die computational time of simulations by two-orders of magnitude relative to using 3-D simulation alone. The process has been demonstrated through the design and optimization of several micrfofluidic systems.

These models describe the operation of the component for applications such as mixing, separation, and pumping in terms of geometric parameters such as length, width, depth, and turn angle, and process parameters such as flow rates and electric fields. The layout, in conjunction with design constraints such as total chip area, detector and inlet port sizes, are analyzed using simulations. The outcome of this procedure is a microfluidic network layout that satisfies input specifications such as .flow rates and inlet/outlet concentrations and Figures of merit such as assay time, sensitivity, chip area. If desired, design verification may be performed using high fidelity simulation software. Upon verification of the layout, further optimization may be performed. After satisfying all performance criteria and verification procedures, the interface translates the layout information into suitable instructions for prototype fabrication.

PHAROS uses compact models for solving pressure-driven and electroosmotic flow in microfluidic devices. Model equations for the flow field are obtained using an integral formulation of the mass (continuity), momentum, and current conservation equations. The coupling between the mass and momentum conservation equations is achieved using an implicit pressure-based technique. In addition, an analytical model for computing analyte dispersion and mixing is used. The analyte is introduced in the buffer in the form of a ‘plug’ and transported under the action of buffer flow and/or by electrophoresis. The dispersion model involves the solution of the advection-diffusion equation An extended method of moments method is used to describe dispersion effects in combined pressure-driven and electrokinetic (electroosmosis and electrophoresis) flow. Volumetric and surface-based biochemical reactions are simulated using method-of-lines (MOL) and two-compartment formulations, respectively. All governing equations are solved on a network representation of the microfluidic system.

The software uses a network approach for describing the microfluidic system. The integrated biomicrosystem is assembled as a network of components, Each of these components can be individually characterized in terms of relevant physicochemical, geometric and process parameters. These components include straight channels, curved bends, Y-junctions etc. The network of components is connected by edges. For the simulator, these edges connecting the components can be described as ‘wires’ of zero resistance, which transfer fluxes of physical quantities (mass, momentum, analyte, electric current) from one component to the next. The solution of the governing equations yields the pressure, voltage, and analyte concentrations at the components, while the flow rate and electric current, from one component to another is computed on the edge.

Compact Models for Fluid Flow and Electric Field

The compact model describing the fluid flow is derived using the integral form of the continuity and momentum equations, while that of the electric current is derived from the current conservation equation. The model assumes the following:
Both flow and electric fields are at steady state,
The fluid is assumed Newtonian and incompressible,
Dilute electrolytes,
Constant electrical conductivity of the liquid,
Electrically neutral buffer solution,
Completely decoupled pressure and electric fields, and
Uniform channel cross sections.

Conservation equations in their integral form are formulated for each component in the network. The continuity equation on component/can be written as:

$${\sum }_{j} {\dot{m}}_{ij} = {\dot{m}}_{i - source} \qquad ( 1 )$$

where, \dot{m}ᵢⱼ is the mass flow from i^{th} to j^{th} component and m_{i-source} is the mass source at the component i. The momentum equation is written for each edge connecting the components i and j:

Pᵢ−Pⱼ=Rᵢⱼ\dot{m}ᵢⱼ (2)

where Pᵢ and Pⱼ) are the pressures at components i and j, while Rᵢⱼ is the resistance to fluid flow (arising from viscous effects) from component i to component j. For a channel of width w, height h and length L, the resistance Rᵢⱼ can be expressed as:

$${R}_{ij} = \frac{( \frac{12 μ L}{ρ h {w}^{3}} )}{( 1 - \frac{192 w}{{π}^{5} h} {\sum }_{i = 1 , 3 , 5 , …}^{∞} \frac{tanh ( \frac{i π h}{2 w} )}{{i}^{5}} )} \qquad ( 3 )$$

where μ is the dynamic viscosity of the buffer. The above relation is valid only in the laminar flow regime. This compact model is fully parameterized and the effect of geometry of the component can be accounted by computing a suitable value of the resistance coefficient. For inertia-dominated flows, resistance becomes a function of velocity. In that scenario, the model has the ability to include resistances by solving the governing equation in an iterative fashion. However, in microfluidic devices, the Reynolds number of the flow is very small (<<1) and nonlinear effects can be neglected.

For the solution of electric fields, current conservation law is solved at: every component (analogous to the continuity equation) along with a constitutive equation relating current and voltage. At a component:

$${\sum }_{j} {I}_{ij} = {I}_{i - source} \qquad ( 4 )$$

where Iᵢⱼ is the current from component i to component j while I_{i-source} is the current source associated with component i. The voltage drop across each edge can be related to the current Iᵢⱼ in the form of a constitutive equation as:

Gᵢⱼ(Vᵢ−Vⱼ)=tᵢⱼ (5)

where the electrical conductance Gᵢⱼ is defined as the inverse of the electrical resistance to current flow from component i to component j, and V is the voltage

Equations (1) and (2) are solved in a coupled manner where the mass flow rate is written in terms of a pressure correction term (derived from a Taylor series expansion of the mass flow rate in terms of pressure):

$${\dot{m}}_{ij} = {\dot{m}}_{ij}^{*} + \frac{\partial {\dot{m}}_{ij}}{\partial {P}_{i}} {p}_{i}^{′} + \frac{\partial {\dot{m}}_{ij}}{\partial {P}_{j}} {p}_{j}^{′} \qquad ( 6 )$$

where the pressure correction pᵢ^{t}=Pₜ−Pᵢ^{*}. The superscript * represents the values at the previous iteration. Substituting above equation in the continuity equation and rearranging the terms, one obtains:

[K]{p^{t}}={f} (7)

where

$$\begin{matrix}{K}_{ij} = {\sum }_{j} \frac{\partial {\dot{m}}_{ij}}{\partial {p}_{j}} & ( 8 ) \\ and & \\ {f}_{i} = - {\sum }_{j} {\dot{m}}_{ij} + {\dot{m}}_{i - source} & ( 9 )\end{matrix}$$

In the above equations, the square brackets represent matrix quantities, while the curly brackets denote vector quantities. By taking the derivative, of the mass flux with respect to the pressure in equation (2), one obtains:

$${K}_{ij} = \frac{\pm 1}{{R}_{ij}} \qquad ( 10 )$$

The coefficient matrix Kᵢⱼ is sparse, but diagonally dominant The fluidic resistance term Rᵢⱼ in equation (10), represents the momentum losses when the fluid flows from component i to component j. An upstream approach is used in assigning proper values to Rᵢⱼ. For example, if the fluid flows from component i to component j, the resistance of component i is used. The solution is obtained using the following methodology:
1. Equation (2) is solved to obtain the mass How rates between each component.
2. The coefficient matrix (Kᵢⱼ) is assembled following the upstream approach.
3. The system of linear equations given by (7) is solved to obtain pressure correction.
4. Pressure is updated.
5. Steps 1 through 4 are repeated until convergence. At convergence, the mass imbalance at each component (fᵢ) is less than the specified tolerance.

The electric potential is computed in a similar fashion by assembling a conductance matrix (G) and solving equation (5), to obtain voltages. Once the electric field is computed, the electroosmotic flow is calculated using the relation

ū_{eof}=ω_{eof}∇V (11)

where ω_{eof} is the electroosmotic mobility, and the arrow represents the vector quantity. However, in this calculation, only the axial component of the velocity plays a significant role. For fluid flow in a linear regime (low Reynolds number flows), it has been shown that the cross-sectional velocity profile in a microchannel resulting from combined pressure-driven and electroosmotic flows can be obtained by superimposing individual profiles for steady state

laminar How. This assumption is used in the derivation of the analytical solution for analyte dispersion based on the “method of moments.”

Analyte Dispersion

An analytical model based on “method of moments” is used for computing analyte dispersion in microfluidic lab-on-a-chip systems. An analyte, introduced in a buffer in the form of a plug is transported under the action of buffer flow and/or by electrophoresis. The dispersion model involves the solution of the advection-diffusion equation and effectively captures the effect of chip topology, separation element size, material properties and electric field on the separation performance. This has been extended to describe dispersion in combined pressure-driven and electrokinetic (electroosmosis and electrophoresis) flow The model includes the effects of parabolic velocity profile in pressure-driven flow and the plug or skewed profiles in electroosmotic flow in straight channels and bends (geometry induced dispersion).

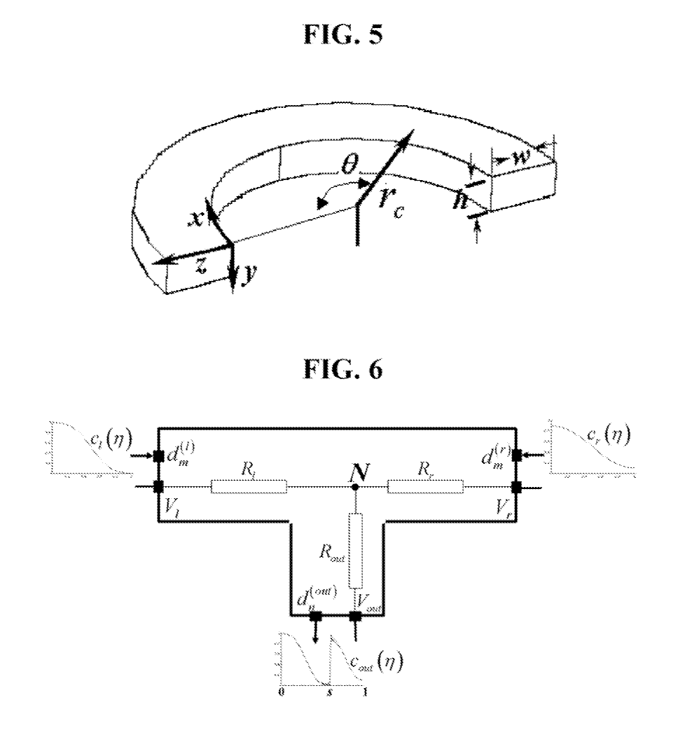

The transport of the analyte is described by the advection-diffusion equation:

$$\frac{\partial c}{\partial t} + \vec{u} \cdot ∇ c = D {∇}^{2} c \qquad ( 12 )$$

where c is the analyte concentration, D is the diffusion coefficient, and fluid velocity ū contains contributions from pressure-driven as well as electroosmotic effects The derivation of the analytical solution consists of recasting equation (12) in a moving coordinate system and calculating moments of the analyte distribution. The pressure-induced dispersion (Taylor dispersion) is calculated using the mass flow rate computed from equation (2). This mass flow rate is used to compute the pressure gradient analytically. The variance and skewness, calculated from the moments of the concentration of the analyte plug, characterizes the dispersion. The solution is derived for a single, constant-radius bend channel shown in FIG. 5, where β(=w/h), r_{c}, θ, b (=w/r_{c}), and L (=r_{c}θ), denote the bend aspect ratio, mean radius, included angle, curvature and mean axial length of the bend, respectively. Extension of the derived solution to a straight channel is a straightforward application with the bend curvature set at zero. The straight and constant-radius bend geometries are elementary constructs that can be used to generate most microfluidic layouts The following assumptions are made in deriving the analytical solution:
The bend curvature (b) is small (<<1).
There are no changes m the cross-sectional area or shape of the bend.
The analytical solution is derived based on the underlying steady state flow and electric field, i.e., migration of the analyte does not induce variations in the fluid properties (dilute approximation).

Calculation of the background flow field:

The background How field consists of contributions from the electroosmotic and pressure-driven flows. In the linear regime and for b<<1, the apparent axial velocity (u′) expressed as.

u=(uₐₖ+u_{Pr})r_{c}/r=(uₐₖ+u_{Pr})/(1−b(1/2−z/w)) (13)

where u_{Pr} is the velocity due to the external pressure, r is the turn radius and r_{c}/r accounts for the difference in axial travel distance at different locations (z) along the bend width (analyte close to the inside wall transits through a short distance). The residence time Δt of the species band's centroid within a bend is then given by:

$$Δ t = \frac{θ {r}_{c}}{( {u}_{ek} + {u}_{Pr} )} \qquad ( 14 )$$

Calculation of Analyte Dispersion:

Equation (12) can be rewritten in the normalized moving spatial and temporal reference coordinate system [ζ=(x−U′t)/h, η=y/h, ζ=z/h and τ=Dt/h²] as

$$\frac{\partial c}{\partial τ} = \frac{{\partial }^{2} c}{\partial {ξ}^{2}} + \frac{{\partial }^{2} c}{\partial {η}^{2}} + \frac{{\partial }^{2} c}{\partial {ζ}^{2}} - Pe χ \frac{\partial c}{\partial ξ} \qquad ( 15 )$$

with, the boundary conditions: ∂c/∂η|_{η=0,1}=0, ∂c/∂ζ|_{ζ=0,β}=0, c|_{τ=0}=c(ξ,η,ζ,0), where χ(η, ζ) denotes the normalized apparent velocity with respect to the apparent axial velocity due to combined pressure driven and electroosmotic flow, Pc=U′h/D is the Peclet number representing the ratio of convection and diffusion, transport rate along the depth of the bend, and U′ refers to the cross-sectional average of u′. In terms of the moments of concentration in the axial filament, equation (10) can be reformulated as:

$$\begin{matrix}\{ \begin{matrix}\frac{\partial {c}_{p}}{\partial τ} = \frac{{\partial }^{2} {c}_{p}}{\partial {η}^{2}} + \frac{{\partial }^{2} {c}_{p}}{\partial {ζ}^{2}} + p ( p - 1 ) {c}_{p - 2} + p Pe χ {c}_{p - 1} \\ \partial {c}_{p} / \partial η {\vert}_{η = 0 , 1} = 0 , \partial {c}_{p} / \partial ζ {\vert}_{ζ = 0 , β} = 0 \\ {c}_{p} {\vert}_{x = 0} = {c}_{p 0} ( η , ζ ) = {\int }_{- ∞}^{∞} c ( ξ , η , ζ , 0 ) {ξ}^{p} d ξ\end{matrix} & ( 16 ) \\ and & \\ \frac{d {m}_{p}}{d τ} = p ( p - 1 ) \overline{{c}_{p - 2}} + p Pe \overline{χ {c}_{p - 1}} \\ {m}_{p} ( 0 ) = {m}_{p 0} = \frac{1}{β} {\int }_{0}^{β} {\int }_{0}^{1} {c}_{p 0} ( η , ζ ) d η d ζ & ( 17 )\end{matrix}$$

where cₚ is the p^{th} moment of the concentration in an axial filament of the analyte band that intersects the cross sections at η and ζ and mₚ is the p^{th} moment of the average concentration across the cross-section. The dispersion parameters describing the shape of the analyte band, such as skewness and variance are obtained from the solution of equations (16) and (17) χ includes both pressure-driven and electrokinetic contributions and varies in both cross-sectional dimensions.

The skewness of the analyte band is expressed as

$${c}_{1} ( η , ζ , τ ) = {\sum }_{m = 0}^{∞} {\sum }_{n = 0}^{∞} {S}_{nm} ( τ ) cos ( n πη ) cos ( \frac{m πζ}{β} ) \qquad ( 18 )$$

where sₙₘ(τ) is defined as the skew coefficient, the Fourier series coefficient of c₁, and is given by

$${S}_{nm} ( τ ) = \{ \begin{matrix}{S}_{nm} ( 0 ) {e}^{- {λ}_{m} τ} + \frac{Pe {χ}_{nm} ( 1 - {e}^{- {λ}_{nm} τ} )}{{λ}_{nm}} & if n + m \geq 1 \\ {S}_{00} ( 0 ) & if n + m = 0\end{matrix} \qquad ( 19 )$$

HereSₙₘ(0) is the skew coefficient at the inlet of the bend, χₙₘ is the Fourier coefficient for the normalized velocity χ and λₙₘ=(nπ)²+(mπ/β)² [n≧0 and m≧0]. The two terms on the right hand side of (19) represent contributions from the skewness at the bend inlet, and the non-uniformity in velocity profiles and axial geometry respectively. Similarly, the variance of the analyte band is expressed as follows.

$${σ}^{2} ( τ ) - {σ}^{2} ( 0 ) = 2 {h}^{2} τ + \frac{2 Pe {h}^{2}}{β} {\sum }_{m = 0}^{∞} {\sum }_{n = 0}^{∞} \frac{{χ}_{nm}}{{v}_{nm} {λ}_{nm}} {S}_{nm} ( 0 ) ( 1 - {e}^{- {λ}_{nm} τ} ) + \frac{2 {Pe}^{2} {h}^{2}}{β} {\sum }_{m = 0}^{∞} {\sum }_{n = 0}^{∞} \frac{{χ}_{nm}^{2}}{{v}_{nm} {λ}_{nm}^{2}} ( {e}^{- {λ}_{nm} τ} + {λ}_{nm} τ - 1 ) \qquad ( 20 )$$

where vₙₘ is defined as v₀₀=1/β, v₀ₘ=2/βand vₙ₀=4/β for n>1 and m>1, σ² (0) represents the variance of tine analyte band at the bend inlet.

System Level Models:

Knowing the residence time of the analyte plug (τ_{R}=Δt·D/h²), the band characteristics at the outlet of the component are computed by substituting into equations (18)-(20), which yields,

$$\begin{matrix}{t}_{i , out} = {t}_{i , in} + Δ t & ( 21 ) \\ {S}_{nm}^{i , out} = \{ \begin{matrix}{S}_{nm}^{i , in} {e}^{- {λ}_{nm} {τ}_{R}} + Pe {χ}_{nm} ( 1 - {e}^{- {λ}_{nm} {τ}_{R}} ) & if n + m \geq 1 \\ {S}_{nm}^{i , in} ( 0 ) & if n + m = 0\end{matrix} & ( 22 ) \\ {σ}_{i , out}^{2} - {σ}_{i , in}^{2} = 2 {h}^{2} {τ}_{R} + \frac{2 {Peh}^{2}}{β} {\sum }_{m = 0}^{∞} {\sum }_{n = 0}^{∞} \frac{{χ}_{nm}}{{v}_{nm} {λ}_{nm}} {S}_{nm}^{i , in} ( 1 - {e}^{- {λ}_{nm} {τ}_{R}} ) + \frac{2 Pe {h}^{2}}{β} {\sum }_{m = 0}^{∞} {\sum }_{n = 0}^{∞} \frac{{χ}_{nm}^{2}}{{v}_{nm} {λ}_{nm}^{2}} ( {e}^{- {λ}_{nm} {τ}_{R}} + {λ}_{nm} {τ}_{R} - 1 ) & ( 23 ) \\ {A}_{i , out} / {A}_{i , in} = \sqrt{{σ}_{i , in}^{2} / {σ}_{i , out}^{2}} & ( 24 )\end{matrix}$$

where index i denotes the i^{th} component in the network and in and out represent the quantities at the inlet and outlet of the component represented by that component. The values of the band characteristics at the outlet given in the above equations are then assigned as the input to the downstream component, that is, t_{i,out}=t_{j,in}, sₙₘ^{i,out}=sₙₘ^{j,in}, σ_{i,out}²=σ_{j,in}² and A_{i,out}=A_{j,in}, where j is the downstream component of i. This protocol enables the transmission of the band characteristics within the entire network from the one component to the next.

Analyte Mixing

The system solver incorporates a lumped-parameter approach to system-level modeling of laminar diffusion based passive micromixers of complex geometry. Mixing modules can be represented as a network of interconnected mixing elements, including microchannels, and Y/T interconnects (mergers with two input and one output streams, and splitters with one input and two output streams). This approach has been extended to account for mixing due to laminar diffusion in both pressure-driven and electric fields.

As the microfluidic mixing channel is typically narrow (w/L <<1 and h/L<<1) and operates at steady state, the axial diffusion of the sample can be neglected and the buffer flow can be treated as axially fully-developed. A large channel aspect ratio (h/L<<1), which occurs in many practical cases, is also assumed to allow an analytical investigation of analyte mixing transport Equation (12) can be rearranged to

$${u}_{x} \frac{\partial c}{\partial x} = D \frac{{\partial }^{2} c}{\partial {z}^{2}} \qquad ( 25 )$$

With analyte insulation boundary condition (∂c/∂z|_{z=0,w}=0), equation (13) be readily solved for a closed-form expression, which is given by,

cₒᵤₜ(z)=dₙ^{(out)} cos (nπη)=dₙ⁽ⁱⁿ⁾e^{-(nπ)}^{²}^{τ} cos (nπη) (26)

where indices in and out stands for the quantity at the channel inlet and outlet, dₙ is the Fourier cosine coefficients of the concentration c, r=Lw/Pc is the dimensionless mixing time; the ratio of the time for an analyte molecule to transit through the channel length to the time for the molecular to traverse the channel width. Equation (26) indicates that analyte mixing concentration, expressed in dimensionless widthwise coordinate η=z/w is uniquely determined by the Fourier coefficients dₙ. Hence, the input-output relationship of dₙ within each mixing element is needed to capane analyte mixing concentration propagated within the entire network.

The Y-merging junction has two inlets and one outlet, and acts as a combiner to align and compress upstream sample streams of an arbitrary flow ratio ,s and concentration profiles side-by-side at its outlet (FIG. 6). As its flow path lengths are negligibly small compared with those of mixing channels, such an element can be assumed to have zero physical size, and be

represented as three resistors with zero fluidic resistance between each terminal and the internal node N, Rₜ=Rᵣ=Rₒᵤₜ=0. Here, N corresponds to the intersection of flow paths and the subscripts l, r and out represent the left and right inlets, and the outlet, respectively. The analyte concentration profiles, and cₗ(η) and cᵣ(η), at the left and right inlets respectively, can be expressed as cₗ(η)=Σ₀^{∞}dₘ^{(l)}cos (mπη) and cᵣ(η)=Σ₀^{∞}dₘ^{(r)}cos (mπη). At the outlet, cₗ(η) and cᵣ(η) are scaled down to the domains of 0≦η≦s and s≦η≦1, where s=\dot{m}ₗ/(\dot{m}ₗ+\dot{m}ᵣ) denotes the interface position (or the flow ratio, the ratio of the left-stream flow rate \dot{m}ₗ, to the total flow rate \dot{m}ₗ+\dot{m}ᵣ) between the incoming streams in the normalized coordinate at the outlet. The non-dimensional s can be determined by solving for flow rate within the entire mixer using flow solver. Then the Fourier coefficients dₙ^{(out)} at outlet, are given by

$$\{ \begin{matrix}{d}_{0}^{( out )} = {d}_{0}^{( 1 )} s + {d}_{0}^{( r )} ( 1 - s ) \\ {d}_{n > 0}^{( out )} = \begin{matrix}\begin{matrix}s {\sum }_{m = 0}^{m \neq ns} {d}_{m}^{( 1 )} \frac{{f}_{1} sin ( {f}_{2} ) + {f}_{2} sin ( {f}_{1} )}{{f}_{1} {f}_{2}} \\ s {\sum }_{m = 0}^{m = ns} {d}_{m}^{( 1 )} + \\ ( 1 - s ) {\sum }_{m = 0}^{m = n ( 1 - s )} {( - 1 )}^{n - m} {d}_{m}^{( r )} +\end{matrix} \\ 2 {( - 1 )}^{n} ( 1 - s ) {\sum }_{m = 0}^{m \neq n ( 1 - s )} {d}_{m}^{( r )} ( \begin{matrix}\frac{cos ( {F}_{2} / 2 ) sin ( {F}_{1} / 2 )}{{F}_{1}} + \\ \frac{cos ( {F}_{1} / 2 ) sin ( {F}_{2} / 2 )}{{F}_{2}}\end{matrix} )\end{matrix}\end{matrix} \qquad ( 27 )$$

where ƒ₁=(m−ns)π, ƒ₂=(m+ns)π, F₁=(m+n−ns)π and F₂=(m−n+ns)π. The analyte concentration profiles at the inlets are scaled down, the Fourier series mode at the inlets is not orthogonal to that at the outlet. Therefore, the modes at the inlet and outlet are expressed in different mode indices (m for inlet and n for outlet). Furthermore, the calculation of the coefficient for a certain Fourier mode at the outlet also depends on the other modes at the inlets. Additionally, analytical models for other basic mixing elements, such as the diverging intersection, sample and waste reservoirs have been developed in a similar fashion.

System-level mixer model from element models:

A complex mixer can be modeled by a combination of element models. The key is to use appropriate parameters to link two element models at their terminals, which correspond to the interface between two neighboring physical mixing elements. Such parameters are illustrated by a hypothetical system consisting of a straight channel, a converging and a diverging intersection. There is a set of interface parameters: concentration Fourier coefficients {dₙ⁽ⁱ⁾}^{j}, where the index i stands for in, out, l or r respectively representing the inlet, outlet, left and right terminals of the element. The index j is the element number. The parameters between two neighboring elements are set equal, e.g., (Vₒᵤₜ)^{j}=(Vᵢₙ)^{j+1} and {dₙ^{(out)}}^{j}={dₙ⁽ⁱⁿ⁾}^{j+1}. This system-oriented simulation approach involves both electric, pressure-driven flow and concentration calculations. First, given the applied potential (or pressure/flow rate) at the reservoirs, system topology and element geometry, the voltages (Vᵢ)^{j} or pressures (Pᵢ)^{j} at the components (nodes) are computed for the entire mixer system using the methodology described previously. The electric field strength (E) [or flow rate] and its direction within each element, and flow ratios (splitting ratios) at intersections are then calculated. The concentration coefficients {dₙ^{(out)}}^{j} at the outlet(s) of each element j are determined from those at the element's inlet(s), starting from the most upstream sample reservoir. As such, electric, flow and concentration distributions in laminar micromixers are obtained. This enables, in a top-down, system-oriented fashion, efficient and accurate design of a complex micromixer.

Reaction Models

Reaction models for both homogeneous and heterogeneous biochemical assays use MOL and two-compartment formulations, respectively Proper parameters are embedded in these element models to enable their integration with other multi-physics and elements, and communicate the sample concentration information to neighboring elements through their interfaces. Two key types of reaction models are considered: reversible surface binding (A+B [symbol] A−B) and homogeneous enzyme-catalyzed reaction, which are coupled to the mixing and flow models.

Volumetric Biochemical Reaction Models:

A biochemical assay involving volumetric reaction typically consists of reservoirs (sample and waste), mixing channels and reactors. For modeling, it is assumed that both the flow and electric fields are at steady state and the model applies to large aspect ratio β far pressure driven flow.

A complete steady state convection-diffusion equation governing the analyte concentration c in an axially fully developed flow is given as

$${u}_{i} \frac{\partial {c}_{i}}{\partial x} = {D}_{i} ( \frac{{\partial }^{2} {c}_{i}}{\partial {x}^{2}} + \frac{{\partial }^{2} {c}_{i}}{\partial {y}^{2}} + \frac{{\partial }^{2} {c}_{i}}{\partial {z}^{2}} ) + {\overline{R}}_{i} \qquad ( 28 )$$

with boundary conditions

$$\frac{\partial {c}_{i}}{\partial z} {\vert}_{z = 0 , w} = \frac{\partial {c}_{i}}{\partial y} {\vert}_{y = 0 , h} = 0 \qquad ( 29 )$$

where subscript represent the quantities of the ith analyte, u is the analyte velocity, D is the diffusivity, and R̅ the reactive source term and its form is specific to different reaction mechanisms. With R̅=0, Eq. 28, reduces to the mixing case.

Similar to the mixing channels, for large channel aspect ratio β, Eq. (28) can be reduced to

$${U}_{i} \frac{\partial {c}_{i}}{\partial x} = {D}_{i} \frac{{\partial }^{2} {c}_{i}}{\partial {z}^{2}} + {\overline{R}}_{i} \qquad ( 30 )$$

where (Uₗ is the cross-sectional average velocity of the ith species. In general, R̅ᵢ involves nonlinear terms, which does not admit, the analytical solution. To achieve a fast and efficient numerical analysis, MOL is employed. The second derivative term in z direction in equation (28) is discretized using the central difference algorithm, which yields a system of ODEs indexed by j,

$${U}_{i} \frac{\partial {c}_{i}^{j}}{\partial x} = {D}_{i} \frac{{c}_{i}^{j - 1} - 2 {c}_{i}^{j} + {c}_{i}^{j + 1}}{{( Δ z )}^{2}} + {\overline{R}}_{i}^{j} \qquad ( 31 )$$

where index j(0≦j≦J) represents the quantities at the ith grid and J is the total cell number in z. An advantage of using MOL is that it allows us to take advantage of the sophisticated numerical packages that have been developed for integrating a huge system of ODEs.

In contrast to the analytical models for mixing elements in which analyte concentration profiles are represented and propagated within the network by Fourier coefficients, the bioreactor model directly delivers the discrete profiles. Therefore, to stitch them together in an integrated assay chip, a pre-reaction converter model that transforms the concentration coefficients to profiles and a post-reaction converter model that works in the reverse manner are needed and respectively,

$$\begin{matrix}{c}_{i}^{j} = {\sum }_{n = 0}^{∞} {d}_{i , n} cos ( \frac{n π j}{J} ) & ( 32 ) \\ {d}_{i , n} = {a}_{n} {\sum }_{j = 0}^{N} {c}_{i}^{j} cos ( \frac{n π j}{J} ) & ( 33 )\end{matrix}$$

where aₙ=1 for n=0 and aₙ=2 for n≠0. The calculation of d_{i,n} in Eq. (31) requires numerical integration.

Reactive source terms in equation (28) are specific to reaction mechanisms. The reaction kinetics for Michaelis-Menten enzyme reactions is governed by

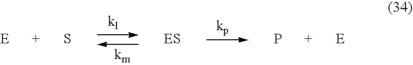

where E, S, ES and P, respectively, represent enzyme, substrate, enzyme-substrate complex and product k₁ and k₋₁ are the forward and backward kinetic constants of converting the enzyme and substrate to the enzyme-substrate complex kₚ, is the kinetic constant for conversion of the enzyme-substrate complex to product. For microfluidic assays that involve non-uniform species concentration, the maximum reaction velocity is not a constant and is dependent, on local enzyme concentration c_{E}. Hence, the reactive source terms for enzyme, substrate, and product are given by

$${\overline{R}}_{s} = - {\overline{R}}_{p} = - \frac{{k}_{p} {c}_{E} {c}_{S}}{{K}_{m} + {c}_{S}} \\ {R}_{E} = 0 \qquad ( 35 )$$

where Kₘ is the Michaelis constant.

Surface Biochemical Reaction Models:

A biochemical assay based on surface reaction includes the same elements as those for volumetric reaction, although the modeling approach and parameters conveyed at interfaces are distinctly different Within most surface bioreactors, transient behavior of transport and kinetics in analyte association and disassociation phases in a depth-wise direction are of primary interest and extensively used to study bio-molecular interactions. Analyte concentration along the. channel width in this case can be treated as uniform. Only the average analyte concentration value at the element interface as well as its propagation within the network needs to be taken into account. For conciseness, average concentration is denoted with c, in the text below. Modeling assumptions are made as follows:
both flow and electric fields are at steady state;
the model only applies to large aspect ratio β for pressure driven flow;
the length of the analyte plug is much larger than that of the channel, so that the dispersion effect during analyte transportation can be neglected; and
analyte concentration at the end of mixing channel is uniform along the channel width.

Consequently only average analyte concentration values need to be considered within the network. Unless otherwise noted, coordinates and notations are same as those used in volumetric reactions.

To capture the transient behavior of each element including the surface bioreactor, the time lag of transporting species in mixing channels must be captured. Assume tᵢ=L/U the residence time of analyte molecules, where t is the channel. Denote cᵢ⁽ⁱⁿ⁾(t) and cᵢ^{(out)}(t) the transient concentration distribution of the analyte detected at the channel inlet and outlet, and they are related by

cᵢ^{(out)}(t)=cᵢ⁽ⁱⁿ⁾(t−tᵢ) (36)

where indices in and out represent the quantities at the inlet and outlet. Equation (36) means that, the transient analyte concentration at the channel outlet can be treated as a translation of that at the inlet by a time lag of tₜ, in which the input analyte molecules are being transported within the channel.

A converging intersection merges two incoming streams from the left and right branches, respectively, with average analyte concentrations cᵢ^{(l)}(t) and cᵢ^{(r)}(t). Because of small flow path lengths, time lag of analyte molecules is neglected. From mass conservation, the average analyte concentration at outlet cᵢ^{(out)}(t) is given by

cᵢ^{(out)}(t)=cᵢ^{(l)}(t)·s+cⱼ^{(r)}(t)·(1−s) (37)

where s denotes the normalized interface position (or flow ratio) between incoming streams as defined as above.

For a diverging intersection, cᵢ⁽ⁱⁿ⁾(t) is the average, analyte concentration at the channel inlet. The average analyte concentrations at the left and right outlets, cᵢ^{(l)} (t) and cⱼ^{(r)} (t), are

cᵢ^{(l)}(t)=cᵢ⁽ⁱⁿ⁾(t) (38)

and

cᵢ^{(r)}(t)=cᵢ⁽ⁱⁿ⁾(t) (39)

Equations (38) and (39) show that average analyte concentration values at the left and right outlet are the same as that at inlet.

Bioreactors:

In a surface bioreactor, the generalized convection-diffusion equation governing free analyte concentrations is given by

$$\frac{\partial {c}_{i}}{\partial t} = {D}_{i} ( \frac{{\partial }^{2} {c}_{i}}{\partial {x}^{2}} + \frac{{\partial }^{2} {c}_{i}}{\partial {y}^{2}} ) - {u}_{i} \frac{\partial {c}_{i}}{\partial x} \qquad ( 40 )$$

with boundary conditions

$$\frac{\partial {c}_{i}}{\partial y} {\vert}_{y = h} = 0 \\ {D}_{i} \frac{\partial {c}_{i}}{\partial y} {\vert}_{y = 0} = {\tilde{R}}_{i} \qquad ( 41 )$$

where R̅ᵢ is the reaction flux on the bottom surface of the channel associated with the ith analyte. The dependence of analyte concentrations in z is neglected because of the assumption of large channel aspect ratios.

Analyte-receptor binding kinetics on the surface are described by

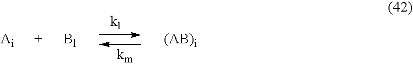

where Aᵢ, Bᵢ and (AB)ᵢ, respectively, represent the ith analyte in flow, immobilized receptor to the ith analyte and ith analyte bound on channel bottom surface.

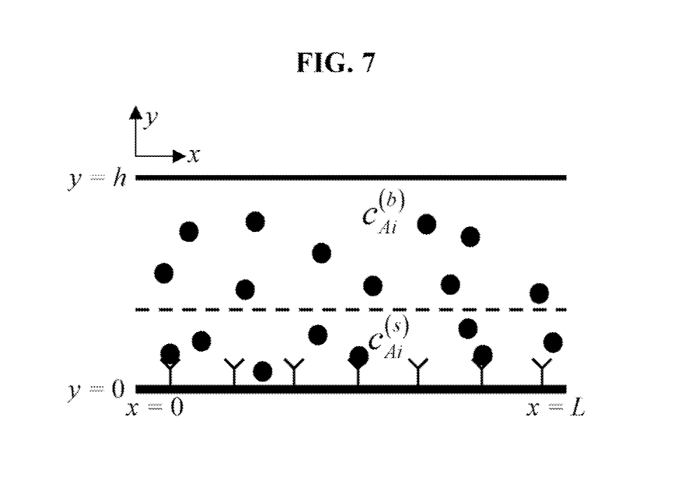

In FIG. 7, a flow cell is divided into two compartments: the surface compartment close to the reactive surface (s) and the bulk compartment (b). Within each compartment, the axially-averaged analyte concentration is spatially uniform but varies with time. The analyte concentration in the bulk, compartment cᵢ^{(b)} holds equal to fresh analyte (cᵢ⁽ⁱⁿ⁾) supplied from the upstream element. The analyte concentration in the surface compartment cᵢ^{(s)} varies with time due to the analyte flux contribution from bulk compartment and reactive surface. From analyte mass balance, the ODEs governing c_{A}^{(s)} and the surface concentration of bound analyte c_{AB} in Equation 42 are respectively given by:

$$\begin{matrix}0 \approx - {k}_{a} {c}_{A}^{( s )} ( {c}_{B}^{T} - {c}_{AB} ) + {k}_{d} {c}_{AB} + {k}_{M} ( {c}_{A}^{( b )} - {c}_{A}^{( s )} ) & ( 43 ) \\ \frac{d {c}_{AB}}{d t} = {k}_{a} {c}_{A}^{( s )} ( {c}_{B}^{T} - {c}_{AB} ) - {k}_{d} {c}_{AB} & ( 44 )\end{matrix}$$

where c_{B}^{T} is the surface concentration (unit: M·m) of total binding sites for ith analyte and c_{B}^{T}−c_{AB} denotes the available binding sites. k_{M} is the transport coefficients capturing the diffusion between the compartments under non-uniform velocity profile in z. In addition, a quasi-steady state assumption of c_{A}^{(s)} within surface compartment is invoked. To obtain the flow-out analyte concentration that is fed to the next downstream element, the mass balance is recast on the entire bioreactor,

Aₛᵤᵣ[−k_{α}c_{A}^{(s)}(c_{B}^{T}−c_{AB})+k_{d}c_{AB}]+UA_{c}(c_{A}^{(B)}−c_{A}^{(out)})≈0 (45 )

where A_{suf} is the binding surface area and A_{c} is the channel's cross-sectional area. Likewise, a quasi-steady state assumption is used for Equation 43. Solution of ODEs (43-45) can be directly integrated by an external numerical package or discretized and assembled into system assembly matrix for direct calculation. The latter approach is preferred to facilitate implementation and speed up simulation.

Interfacing the Software with Microfabrication Environment:

The layout generated from the design process may be transferred to a CAD environment such as DXF™ for fabrication. The DXF™ format is a tagged data representation of all the information contained in an AutoCAD® drawing file. The output DXF file exported from PHAROS may contain the instructions and additional information necessary for the fabrication process such as layers and alignment.

Validation of the Flow and Electric Field Compact Model:

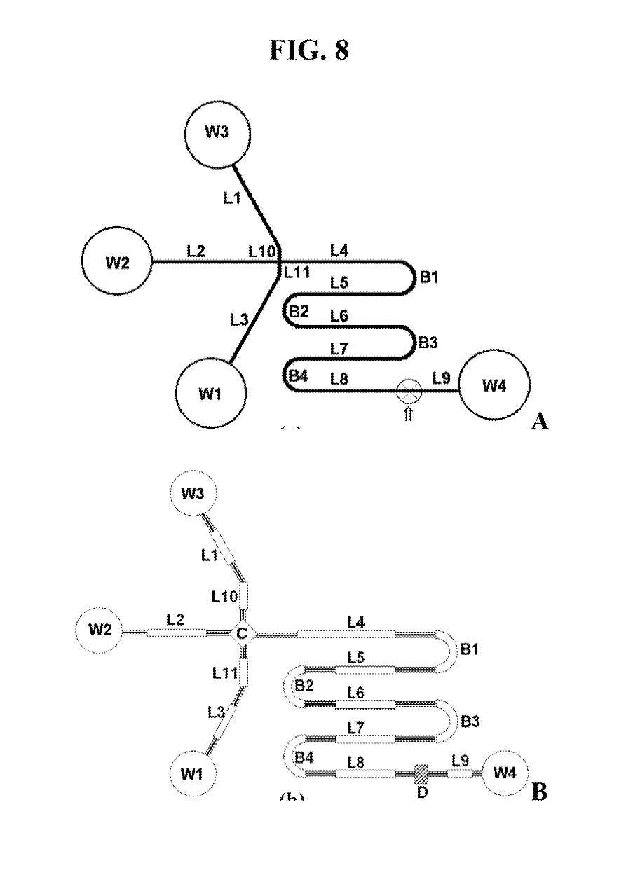

Simulations of analyte migration and subsequent separation in pressure-driven and electroosmotic flows using the system solver compact model were validated by comparison with detailed 3-D simulations using a commercial software product, CFD-ACE+® (ESI Group). The design of a separation chip used for validation is shown in FIG, 8A. The corresponding layout as viewed in the PHAROS layout editor is shown in FIG. 8B. The system comprises injection channels L1/L10 and L3/L11, buffer channel LZ and a serpentine-shaped separation channel comprising straight channels L4-L8 and bends B1-B4. Injection channels L1/L10 and L3/L11 are connected to analyte reservoirs W1 and W3. Buffer channel L2 is connected to buffer reservoir W2. The separation channel empties into waste reservoir W4. The analyse and waste reservoirs (W1-W4) act as boundary conditions for the model The effects of momentum losses due to changes in the orientation of the geometry, for example between components L3 and L11 of the injection channel, are neglected.

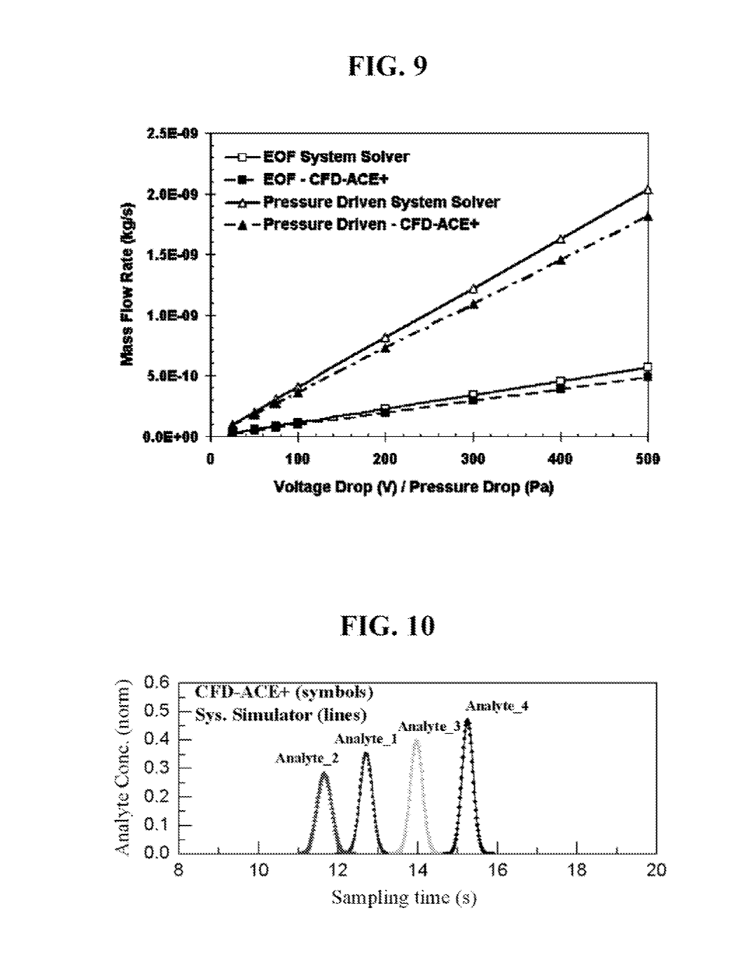

All channels are 50 microns wide and 25 microns deep. The channel lengths are L1=L13=2200 μm, L10=L11=200 μm, L4=1800 μm, L5=L6=L7=1500 μm, L8=1000 μm. Bends B1-B4 have a mean turn radius of 250 μm. The cross-junction and detector D are assumed to be point entities that do not have any electrical or hydrodynamic resistance. The buffer has a density of 1000 kg/m³, a kinematic viscosity of 1.0×10⁻⁶ m²/S, and an electroosmotic mobility of 1.0×10⁻⁸ m²/(V s) The net mass flow rate into the waste reservoir was compared to results obtained from a corresponding 3-D simulation (FIG. 9) The variation of mass flow rate at the outlet boundary due to pressure-driven or electroosmotic flow is linear with respect to the applied inlet pressure or voltage respectively. The maximum error obtained was less than 10% for Reynolds numbers of less than 1. The system solver compact model completed the simulation in less than 1% of the time required for the 3-D simulation. An average simulation of electroosmotic and pressure-driven flow using the system solver takes less than 1 second, while the 3-D model takes about 270 seconds on a MS-Windows workstation with a 2 GHz. 1 GB RAM CPU.

Validation of the Analyte Dispersion Model

The dispersion model was validated for the separation of a sample comprising four different positively charged analytes of unit valence with different mobilities and diffusivities. The sample is injected at the cross junction of the separation chip shown in FIG. 8 and detected at the end of the serpentine section at detector D. The properties of the analytes used in the simulation are summarized in Table 1.

TABLE 1
Analyte Units Used in Simulations

| | Diffusivity | Electrokinetic |
|---|---|---|
| Analyte | [m²/s] | Mobility [m²/(V s)] |
| Analyte_1 | 1.0 × 10⁻¹⁰ | 3.0 × 10⁻⁸ |
| Analyte_2 | 3.0 × 10⁻¹⁰ | 3.27 × 10⁻⁸ |
| Analyte_3 | 6.0 × 10⁻¹¹ | 2.73 × 10⁻⁸ |
| Analyte_4 | 3.0 × 10⁻¹¹ | 2.5 × 10⁻⁸ |

The sample is transported by electrophoresis alone at E_{αν}=300 V/cm using the same buffer properties as those described in the previous example. During 3-D CFD-ACE+® simulations, the species bands with Gaussian concentration distributions were initially injected at 200 μm downstream of the cross intersection. The comparison of the detected electropherograms between the system simulator and CFD-ACE+® 2000 μdownstream of the last bend is shown in FIG. 10). Due to the difference in analyte mobilities and diffusivities, all bands exhibit different shape and dispersion behavior. Results of the two simulations differed by less than 6.5% for all analytes. This includes the extent to which each analyte band was distorted as it moved through the bends. This simulation demonstrates that the system solver accurately captures the effects of electric field, analyte properties, chip topology, and channel dimensions on the dispersion. The high-fidelity model simulation with sufficient grid density to capture the dispersion effects required 48 hours of computing time, compared to less than 5 seconds for the system solver.

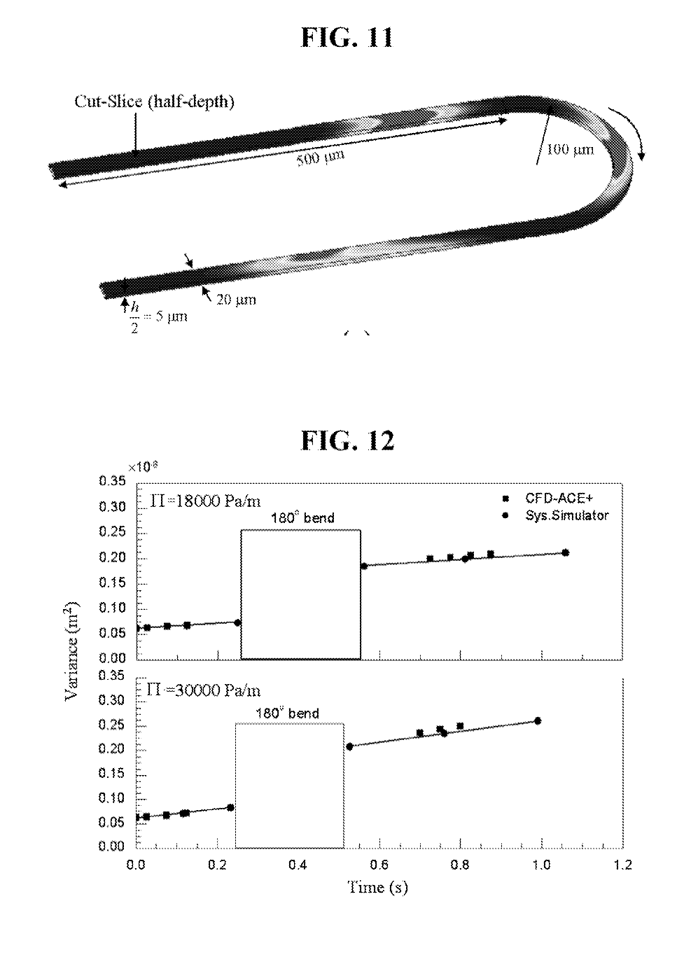

Accurate 3-D and transient CFD simulation of analyte transport by both pressure-driven and electrokinetic flow in a full microfluidic network such as the one described in FIG. 8 is prohibitively expensive. A simplified geometry used to validate the analytical model for combined flows is shown in FIG. 11. The sample consists of the same four analytes listed in Table 1. FIG. 11 also shows the state of the Analyte 1 plug at several locations. The analyte band is initially injected at the middle of the first channel, where both pressure-driven and electrokinetic flow act in the same direction. Obvious analyte band distortion, due to pressure-driven flow is evident (parabolic interface matching with the parabolic flow profile typical of a. pressure-driven laminar flow) even within the straight channel, in the turn, the analyte molecules at the inside wall move faster and travel a shorter distance compared to those at the outside wall, leading to a very sharp skew. FIG. 12 shows the effect of transit time on the variance of the band as it moves through the microchannel network. The grey bars refer to the residence of the analyte bands within the turns. As anticipated, the variance of the analyte band increases as the sample transits the network. The results from the system simulator are compared with CFD-ACE+® for two different values of pressure gradient (Π=18000 and 30000 Pa/m), while keeping the electric field (E_{αν}=300 V/cm) constant and differ by less than 5%.

Validation of the Analyte Mixing Model:

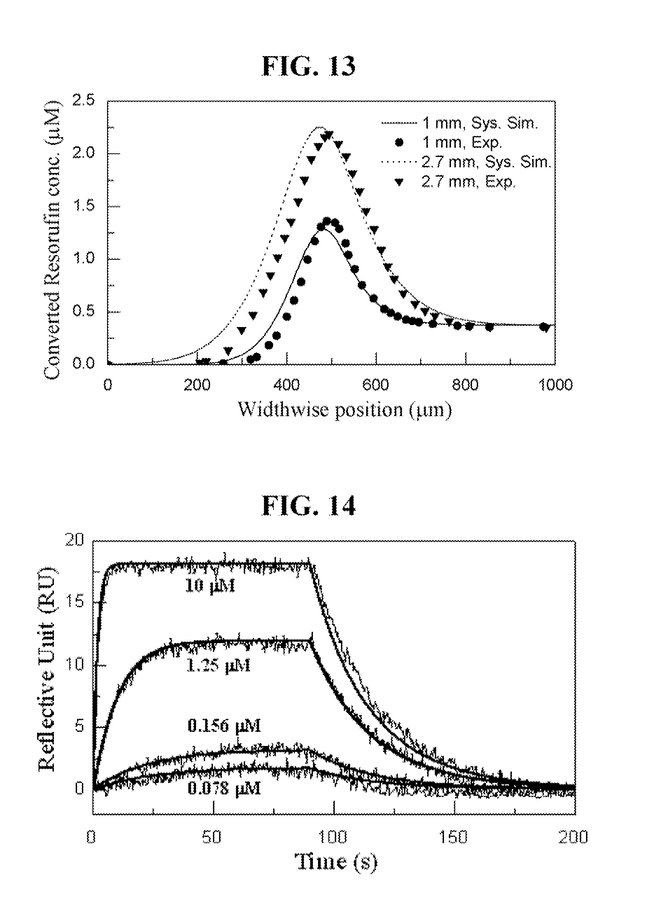

The system-level model was applied to simulations of several biochemical assays, including mixing, volumetric, enzymatic reaction, and reversible surface analyte-receptor binding method steps. The simulation results were validated against corresponding full 3-D validated CFD-ACE+® modeling results. FIG. 13 illustrates the results from the system simulation and CFD-ACE+® analysis on the widthwise concentration profiles β-galactosidase at different locations within an enzymatic assay chip. Relative error was less than 6.3% between the compact system simulation and numerical results from the 3-D simulation. The compact model simulations ran 10,000× faster than the CFD-ACE+® simulations.

System modeling of reversible binding was validated against published data. FIG. 14 shows the comparison between transient simulations (smooth curves) and BIACORE (Biacore .International SA) data (fluctuating curves) on the kinetic analysis of the binding of acetazoiamide (analyte) to surfaced-immobilized anhydrase-II (receptor). Analyte in a buffer solution enters a receptor-coated channel at a constant rate for a period of 90 s, at which time buffer flow continues without analyte. The simulations were performed for four different concentrations of analyte. The surface concentration of bound analyte is linearly proportional to the Reflective Unit and increases with time. RU rises at a decreasing rate as available anhydrase-II binding sites become saturated. After analyte supply is terminated, bound analyte disassociates and RU decreases.

Validation of Electrophoresis Modeling.

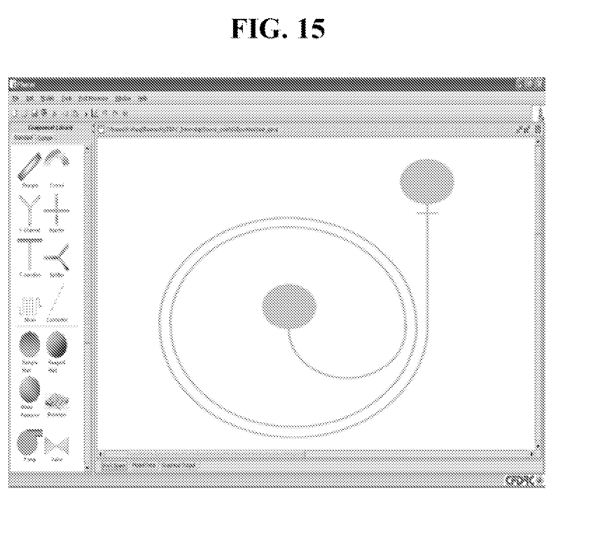

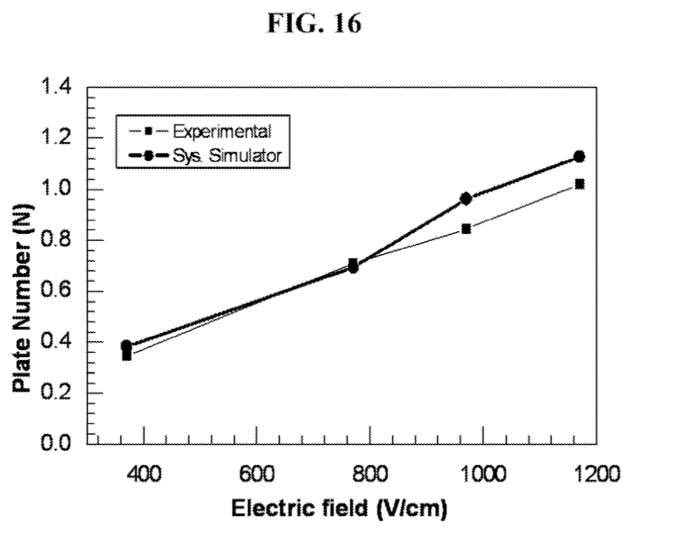

The system simulator was validated against experimental data used for the design analysis of an efectrophoretie separations chip. FIG. 15 shows the network representation (layout) inside PHAROS corresponding to the microfluidic system. FIG. 16 compares the plate number predicted by the simulation to those observed experimentally as a function of imposed electric field.

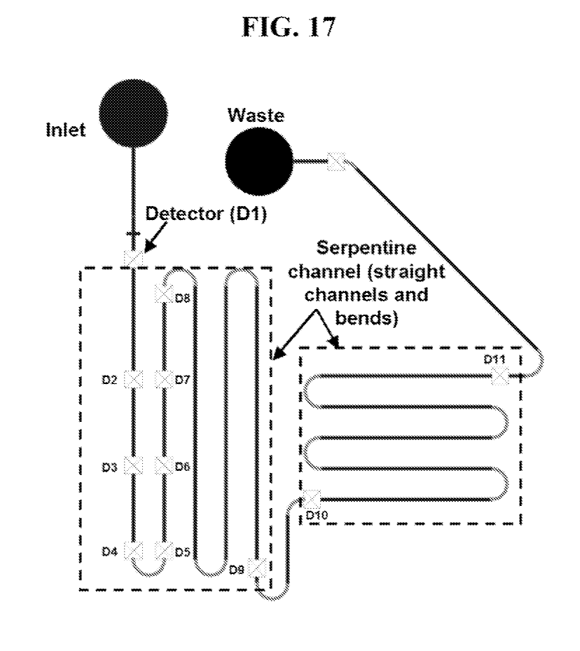

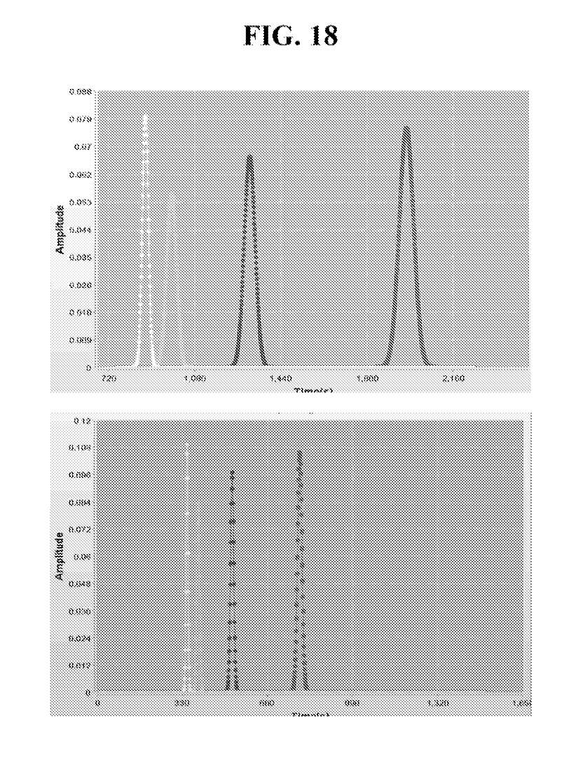

A system level simulation of a CE microfluidic network was performed to estimate dispersion. The electrophorefic chip used is shown in FIG. 17 It consists of an inlet through which the buffer is introduced and a user-specified injector (paced near the inlet, not shown) through which a sample containing analytes A, B, C, and D is introduced. The sample migrates through a long, winding microchannel, detectors (D1-D11), and finally into a waster reservoir. FIG. 18A shows an electropherogram of analytes A, B, C, and D at detector D4 from a sample simulation. The analyte electrophoretic mobilites are 10⁻⁸, 2×10⁻⁸ and 4×10⁻⁸ m²/Vs, respectively. The electroosmotic mobility of the channel substrate is 10⁻⁸ m²/Vs. The channel width is 50 μm; bends have an outside diameter of 300 μm, and straight channels are 500 μm long. An electric potential of 100 V is applied at the inlet and grounded at the exit. These results are in agreement with experimental observations. FIG. 18B shows a second electropherogram of analytes A, B, C, and D at detector D4 in which the simulated voltage was 250 V. The increased inlet voltage reduced both, the separation time and the distance between analyte peaks In accordance with experimental observations. The approximate CPU time for a typical simulation was 40 seconds.

Simulation results for the above analytes using a validated model implemented in CFD-ACE+® were compared with the corresponding compact model for pressure gradients of 18000 and 30000 Pa/m and an electric field of E_{αν}=300 V/cm. A difference of less than 5% was observed between the two simulations.

Optimization:

Integrated biochip systems can be optimized in several ways. For example, one may wish to optimize the operating conditions for a particular layout with or without altering the dimensions or arrangements of system components. Optimization of the substrate dimensions upon which biochip systems are assembled may involve rearrangement, resizing, and/or replacement of system components. Regardless of the specific optimization to be performed, targets to be met by optimization must be identified, as well as variable and invariable parameters.

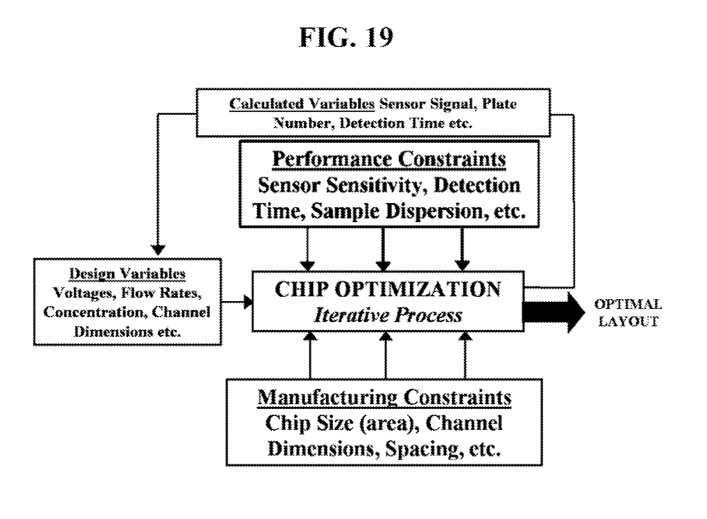

One example of an optimization process that can be implemented in PHAROS is shown in FIG. 19. Data representing design variables and performance and manufacturing constraints are provided to an optimization algorithm mat combines system simulations with automated selection of design variable changes based on comparisons between simulation results and performance values to be optimized. The new dew design variables are automatically provided to the optimization algorithm for simulation and comparison of results with desired performance criteria. The process is repeated in an iterative fashion until the desired performance criteria are met.

For a generalized microfluidic chip, the objective function could be formulated in terms of a single or multivariate objective such as minimum layout area, minimum detection time, and maximum signal strength. Examples of performance constraints include minimum signal strength generated by a sensor, sensor sensitivity of the detector used, and maximum time allowed from assay start to detector signal. Manufacturing-(fabrication) constraints may include, for example, device or microfluidic system dimensions, weight, and power requirements and channel dimensions. Examples of design variables that, can be optimized include channel dimensions, voltages, flow rates, pressures, and time-dependent electric field profiles.

### EXAMPLE 1

### Micromixer Chip Simulation

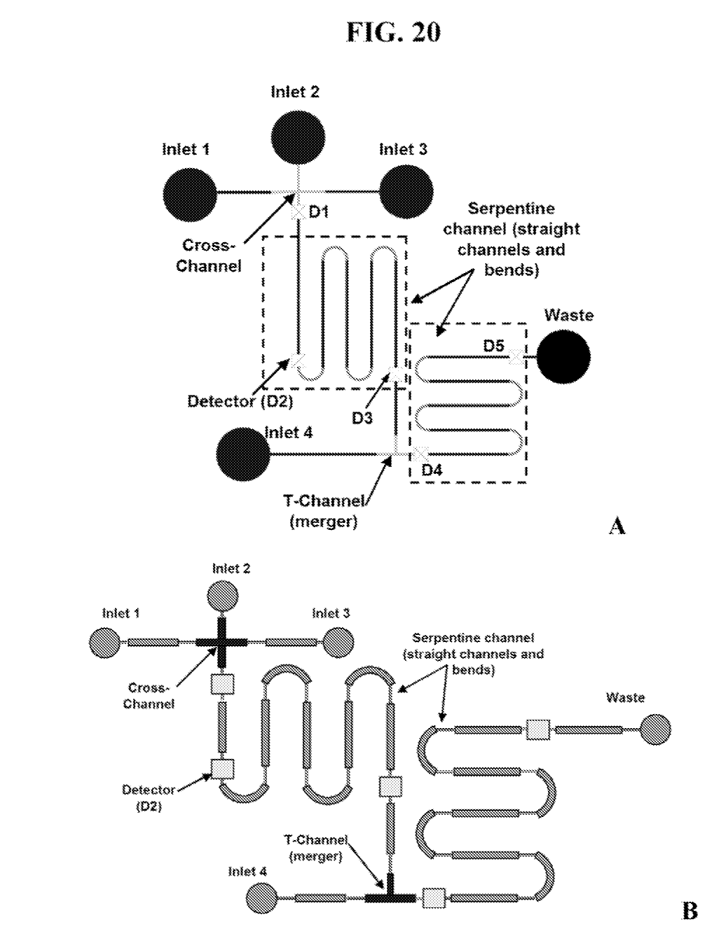

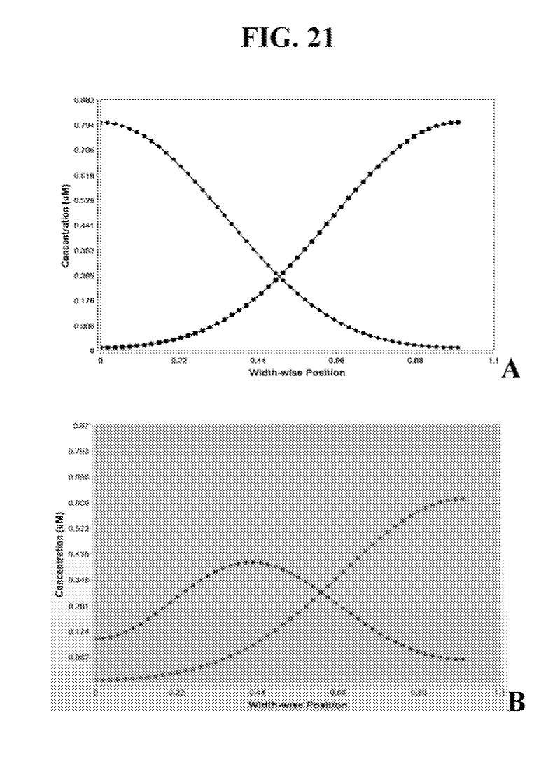

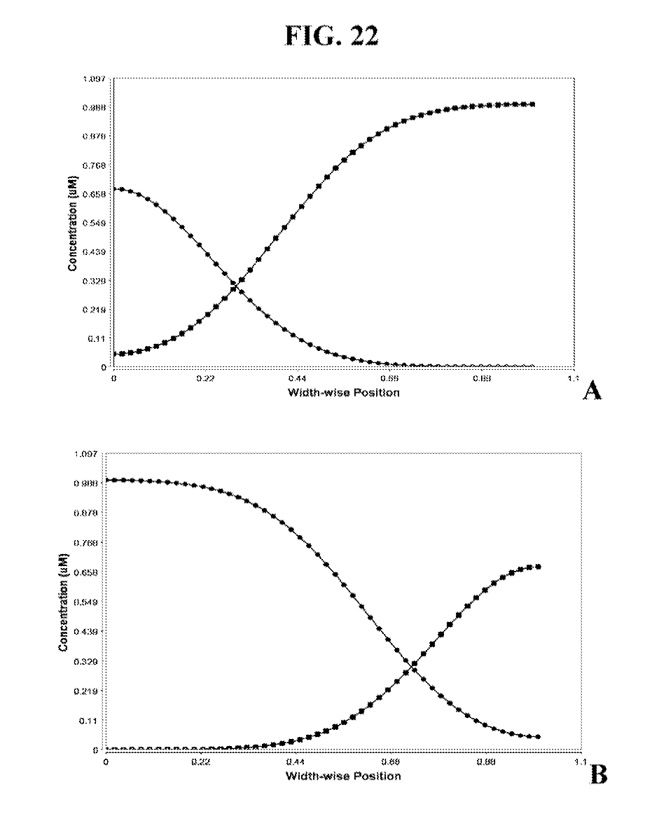

The mixing of three reagents by a passive micromixer was modeled. FIG. 20A and 20B show the initial design and corresponding layout of the micromixer. The micromixer comprises four inlets and one outlet. Analytes A and B are pumped into the system continuously via inlets 1 and 3, while analyte C is introduced via inlet 4. Inlet 2 regulates analyte concentrations by introducing diluting buffer. There are two serpentine channels in the system that function as a micromixer to mix A and B, followed by mixing with C. Diffusion is the primary mixing mechanism in this design, and the level of mixing depends on the residence time, which in turn depends on the flow velocity and length of the serpentine channels. After creation of the layout (FIG. 20B), simulations were performed to predict the effects flow rate on concentration profiles at predefined detector locations. Analyte concentration profiles along the channel cross-section at detector locations D2 and D5 are plotted in FIG. 21A and 21B for flow rates of 0.5 μL/min for both A and 8. When the flow rates arc unequal, asymmetric concentration profiles arc observed. As illustrated in FIG. 22A and 22B, show the concentration profiles at D2 when the flow velocity is changed to 0.324 μL/min for solution containing analyte A or B. The approximate CPU time for a typical simulation was 20 seconds.

### EXAMPLE 2:

### Optimization of a RNA Extraction Chip

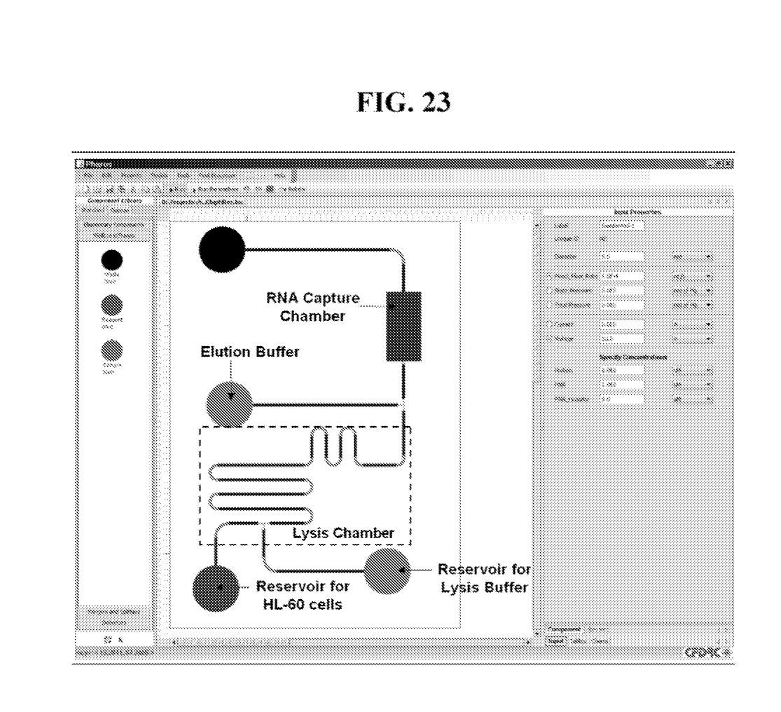

The operation of a cell lysis microfluidic chip was simulated and optimization parameters identified. FIG. 23A shows a PHAROS network representation of the biofluidic chip, which comprises lysis and capture chambers, reservoirs for cells, lysis buffer, elution buffer, and purified RNA and waste. These reservoirs are connected to off-card pressure pump(s) and a power supply using appropriate interfaces (not shown)

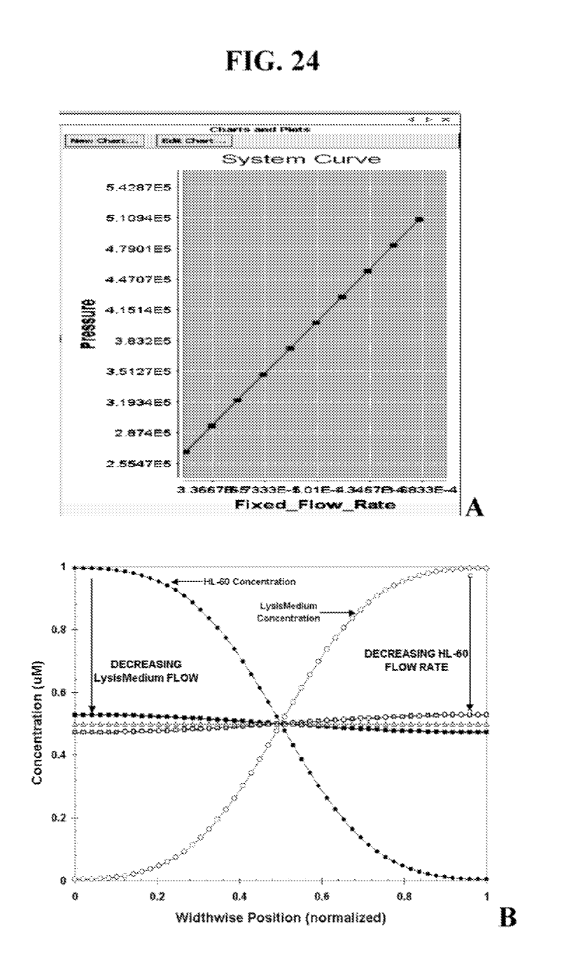

Cell lysis is the first step in RNA extraction from cells and directly influences the yield and quality of the isolated RNA. Cell lysis must be rapid and complete to prevent RNA degradation by endogenous RNases. The reagent lysis chamber comprises a Y junction channel followed by multiple serpentine channels. Mixing of the lysis with the cell sample must be complete to achieve, complete cell lysis and to minimize the associated pressure drop. PHAROS was used to create the layout of the chip and simulate mixing and cell lysis in the lysis chamber and the pressure drop in the complete system, FIG. 24A shows a graph of the pressure drop versus lysis buffer flow rate and FIG. 24B plots the effect of cell and lysis buffer flow rates on mixing at the exit from the lysis chamber. Reducing the flow rate reduces the pressure drop and increases mixing, but the increased residence times increase the time required for lysis and RNA collection. Optimal process conditions can now be calculated based on the competing constraints shown in FIG. 24A and 24B.

### EXAMPLE 3:

### Optimization of a Blood Oxygen Sensor Using ANNs and Multiphysics Models

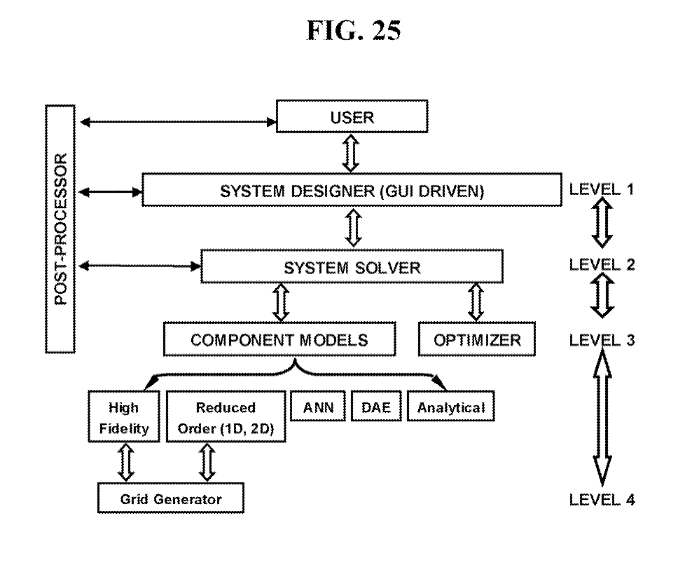

Mixed Methodology modeling may include the use of artificial neural networks (ANNs) and/or one- or multi-dimensional multiphysics models. Some multiphysics models may require grid generation. The inclusion of these types of models in the PHAROS unified design environment is shown in FIG. 25.

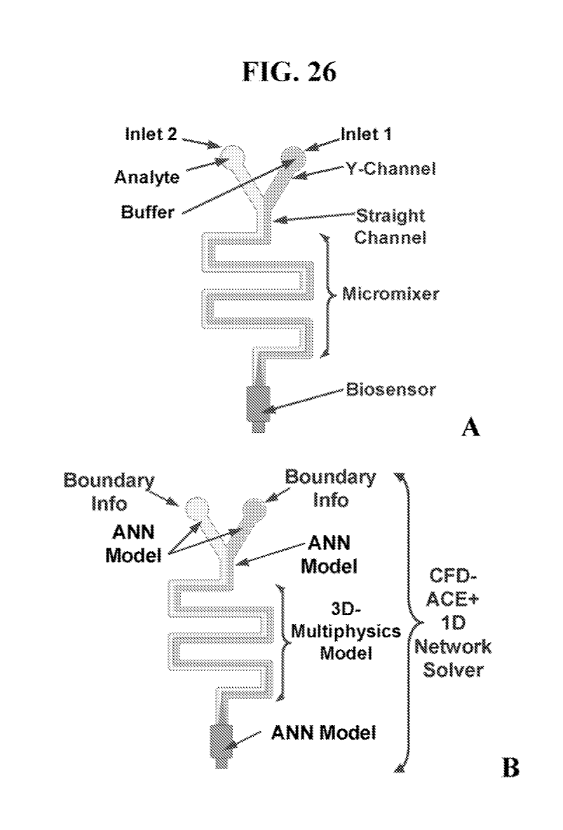

The operation of a blood oxygen sensor assembled from standard microfluidic components was simulated using a Mixed Methodology approach to predict the pressure drop and biosensor signal for the full system. The design of the blood oxygen sensor is shown in FIG. 26A. FIG. 26B indicates the modeling techniques associated with each component in the sensor.

Table 2 compares simulation results from traditional 3-D modeling with the results of Mixed Methodology modeling of the oxygen sensor. There is nearly a 350-fold decrease in the computational time when moving from a full 3-D to a mixed methods simulation. A two-parameter method was used to transfer boundary information across microfluidic components without losing underlying physics in terms of mixing levels of bioanalyte and buffer.

TABLE 2
Comparison of Full 3D vs. Mixed-Methodology Simulation

| | CFD-ACE+ | Mixed |
|---|---|---|
| | (Full 3-D Simulation) | Methodology |
| Total Press. Drop | 31.65 | 27.5 (13.1%) |
| (Pa) | | |
| Biosensor Current | 809.0 | 745.2 (6.8%) |
| (mA/m²) | | |
| CPU Time (s) | 6216 | 15 |

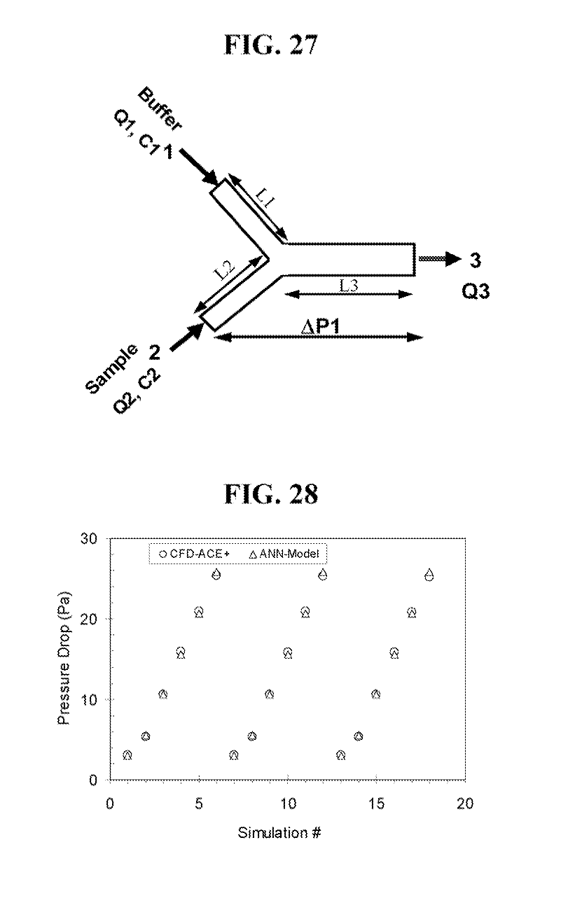

The Y-junction shown in FIG. 26 was modeled as an ANN model. It consists of 2 inlet arms of length L1 and L2 (FIG. 27) meeting at angle α. The channels are 250 μm wide and 100 nm deep. Buffer enters through the Inlet 1 at a flow rate Q1 and the sample enters through inlet 2 with a flow rate of Q2 and oxygen concentration of C2. At the Exit 3, the degree of sample mixing, described in terms of average analyte concentration C̅ and standard deviation σ, depends upon the flow rates and channel dimensions. Table 3 lists fixed and variable parameters associated with the operation of the Y-junction component.

TABLE 3
Y-Junction Parameters
FIXED PARAMETERS

| | |
|---|---|
| Geometry | L3 500 μm (FIXED) |
| | α = 120 deg (angle between arms) |
| | Cross-Section: 250 μm wide × 100 μm deep |
| Process | Q2 1 μL/min (Sample Flow Rate) |
| | C1 0 M |

VARIABLE PARAMETERS

| | |
|---|---|
| Geometry | L1 = L2 = 2, 6, 10 mm |
| Process | Q1 = 1, 2, 4, 6, 8, 10 μL/min (Buffer flow rates) |
| | C2 = 1.13e−04, 1.41e−04, 1.69e−04, M ([O₂] in Sample) |

High fidelity 3-D multiphysics simulations were used to generate data for ANN training. The ANN training data represented 18 sets consisting of 2 inputs and 3 outputs. The equivalent ANN reduced model used a fully connected Multi Layer Perceptron (MLP) configuration with a 2-20-3 topology, that is 3-inputs, 20 neurons in one hidden layer, and 3-outputs.

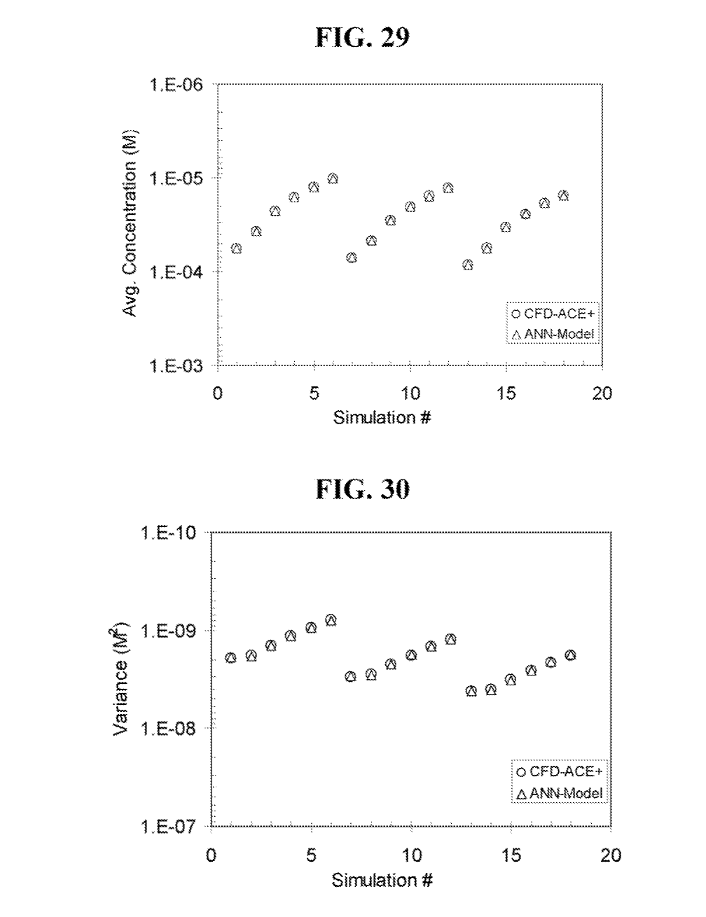

FIGS. 28-30 plot, we the predicted output from the multiphysics model and those from the trained ANN model for pressure drop, average concentration and variance in concentration profile, in ail the FIGS., results computed using the trained ANN model matched well with multiphysics simulations data. Total training time was 10 sec on a 1.2 GHz processor.

Similar procedures were used to simulate the operation of the straight channel and the biosensor components. The results of trained ANN simulations of pressure drop, analyte concentration, and variance were within 0.5% of multiphasis simulation results for the Y-junction and straight channel and within 7% for the biosensor. The total computational time was less than a second for trained ANN model vs. several minutes for full-scale 3D simulation.

A 3D multiphysices model was used to simulate the micromixer component of the sensor in FIG. 26. The inlet boundary conditions were specified via user defined boundary conditions that read output data from the linear channel or Y-junction ANN component model. The multiphysics model was solved for the transport of O₂ in the micromixer. A model generator based on Python scripts was used to automate model setup. A fully automated Simulation Manager tool, available in CFD-ACE+® software was used to rapidly generate geometric CAD models for the components and simulation of multiphysics models. Detailed 3-D multiphysics simulations were used to generate comprehensive data sets that relate the pressure drop with the identified input parameters.

This approach to information exchange for mixed methods simulations can be easily extended for other variables such as velocity, pressure, electric field etc. using appropriate conservation laws for parameter estimation (e.g. using conservation of mass to generate a velocity profile for a multiphysics model using the flow rate output by an ANN or DAE.)

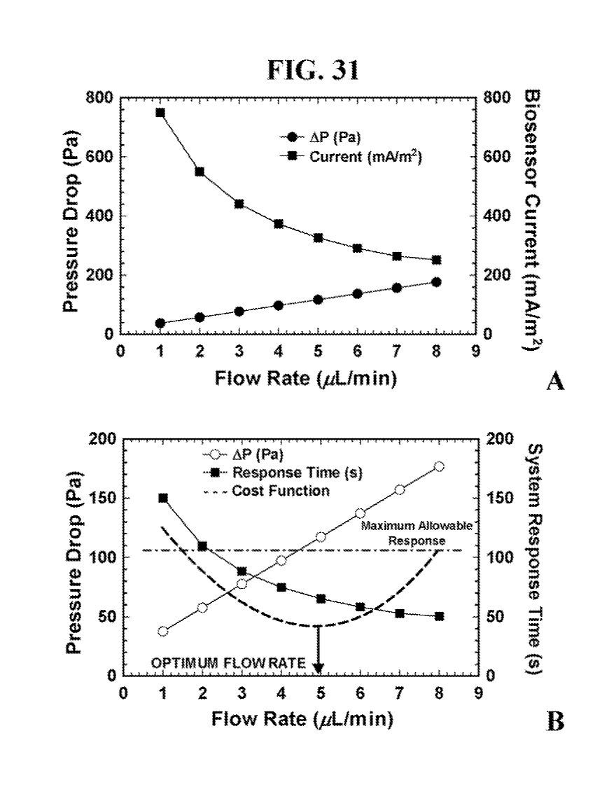

The effect of variation in buffer inlet flow rate on the system output (Pressure drop, biosensor current) is shown in FIG. 31A. The pressure drop increases linearly with the flow rate, while the biosensor signal decreases non-linearly with increased flow rates. In this event, the best-case situation would be at the lowest possible flow rate that would give the lowest pressure drop and the highest signal at the biosensor.

However, when in addition to the pressure drop, the response time of the biosensor is also considered, a more complex picture emerges. When the flow rate is increased, the pressure drop increases (unfavorable.) and the peak signal from the biosensor decreases, but the response time of the sensor decreases (favorable). So the system level design problem is posed as an optimization problem. Depending upon the constraints upon the energy available for fluid pumping (directly related to the pressure drop) and the limits of detection (LoD) for the biosensor signal, a cost function can be formulated. This can be written as

cost=w·f(ΔP)+(1−w)g(t) (46)

where w, (1−w) are the cost coefficients, while ΔP and t are the pressure drop and the biosensor response time respectively. The constraints on the problem can be posed as I≧Iₘᵢₙ (minimum current that can be measured, LoD) and t≦tₘₐₓ (maximum permissible response time for the sensor. Depending upon the actual form of the functions f and g in the cost function, the problem can be solved by either maximization or minimization of the cost function. FIG. 31B shows a schematic representation of the minimization approach.

The ANNs used are able to predict “outputs” for a given set of “inputs” but cannot be used if the roles of inputs and outputs are reversed. As a result, one cannot predict flow rate through a component, if the pressure drop across it was known. The same applies for current-voltage relationships. This drawback can be removed by “re-training” the ANN by reversing the inputs and outputs using the same training data. For most components, the amount of time needed to train the ANN is insignificant compared to that required for generating the training data. Another approach is the use of a Newton-Raphson based solution algorithm to invert the curve fit generated by the ANN.

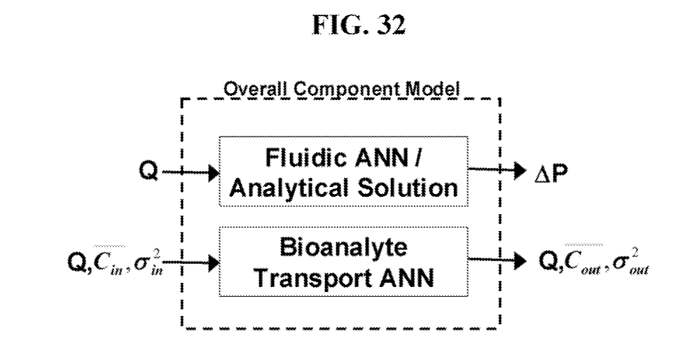

A single ANN was used to characterize both fluidic and species transport behavior. However, for most microfluidic lab-on-a-chip devices, the fluidics can be decoupled from bioanalyte transport since the buffers used are normally very dilute. As a result, it is advantageous to incorporate this segregation of fluidics and bioanalyte transport into the ANN methodology. A separate (parallel) ANN can be used to represent the two. This is illustrated schematically in FIG. 32, which shows that pressure drop can be predicted using a “fluidic” ANN based on the flow rate, while the concentration distributions of bioanalytes is predicted using a separate ANN.

The fluidic ANN can also be replaced by analytic expressions for pressure drop, which are available for many standard components. Depending upon the phenomenological complexity of the component, it may be advantageous to use multiple ANNs in series to characterize a component.

It will be appreciated by those having ordinary skill in the art that the examples and preferred embodiments described herein are illustrative and that the invention may be modified and practiced a variety of ways without departing from the spirit or scope of the invention. A number of different specific embodiments of the invention have been referenced to describe various aspects of the present invention. It is not intended that such references be construed as limitations upon the scope of this invention except as set forth in the following claims.

What is claimed is:

1. A computer method for designing a microfluidic device comprising:
a) providing a set of target performance parameters for the microfluidic device,
b) creating a layout representing a design for the microfluidic device, the layout comprising a collection of connected microfluidic components,
c) simulating the operation of the design for the device using a mixed methodology model to obtain simulated performance parameters for the initial design,
d) comparing the simulated performance parameters for the design with the set of target performance parameters for the microfluidic device,
e) altering the layout or operational parameters to generate a modified layout representing a modified design for the microfluidic device,
f) simulating the operation of the modified design for the device using a mixed methodology model to obtain simulated performance parameters for the modified design,
g) comparing the simulated performance parameters for the modified design of the microfluidic device with the set of target performance parameters for the microfluidic device, and
h) repeating method steps (e)-(g), if necessary, altering the layout or modified layout until the simulated performance parameters for a final modified design of the device satisfy the set of target performance parameters for the microfluidic device.

2. The method of claim 1 wherein the collection of microfluidic components comprises a plurality of one or more of a channel, an expanding channel, a contracting channel, a bend, a mixer, a reaction chamber, an electrode chamber, a reagent well, a waste wells, a cross channel, an injector, a junction, a pump, a valve, a reservoir, a heating element, a detector and a sensor.

3. The method of claim 1 wherein the mixed methodology model comprises two or more of an analytical model, a numerical model, and a reduced order model.

4. The method of claim 1 wherein the mixed methodology model comprises two or more of a method of moments model, a two compartment model, a method of lines model, a method of moments model, an integral form of a Navier-Stokes model, and a Fourier series model.

5. The method of claim 1 wherein simulating the operation of the design or modified design comprises the simulation of two or more of liquid filling, pressure-driven laminar flow, electrothermal flow, electroosmotic flow, analyte separation, dispersion, mixing, analyte preconcentration, detection of analytes, detection of reaction products, dielectrophoresis, an electric field, a thermal field, a magnetic field, joule heating, microbead transport; a chemical reaction, a biochemical reaction, and an electrochemical reaction.

6. The method of claim 1 wherein altering the layout comprises one or more of altering component dimensions, adding components, altering components, and deleting components,

7. The method of claim 1 wherein altering the operational parameters comprises one or more of altering flow rate, analyte concentration, buffer composition, fluid compositions, a physical or chemical property of a fluid, pressure head, temperature, applied voltage, and time-dependant electric field profiles,

8. The method of claim I wherein the target performance parameters are selected from, analyte detection limits, pressure drop, time required for analyte detection, separation time, purification level, and maximum operating temperature.

9. The method of claim 1 wherein altering the layout or operational parameters is performed by a computational optimization algorithm.

10. The method of claim 9 wherein the computational optimization algorithm applies design constraints selected from device geometry, device size, device cost, device weight, flow rate, concentration, applied electric field, power requirements, microfluidic channel dimensions, detector signal strength, detector sensitivity, and assay time.

11. The method of claim 1 further comprising: exporting the layout of the final modified design in a CAD format for automated fabrication of the device.

12. A computational method for predicting the operational performance of a microfluidic system comprising:
a) creating, on a computer, a layout representing the microfluidic system, the layout comprising a collection of microfluidic components or devices from a component and device library,
b) providing initial input parameters for the operation of the microfluidic system, and
c) computationally simulating the operation of the microfluidic device using a mixed methodology model to obtain simulated operational performance output parameters for the device.

13. A computational method for optimizing the design of a microfluidic device comprising:
a) a user provided data tile specifying target functional parameters and constraints for the device,
b) constructing an initial microfluidic network layout from a database of microfluidic components,
c) computationally simulating the operation of the initial microfluidic network to predict its functional parameters,
d) using a computer algorithm to compare the functional parameters predicted in step (c) with target functional parameters of step (a) and to construct a modified microfluidic network layout,
e) computationally simulating of the operation of the modified microfluidic network to predict its functional parameters, and
f) repeating method steps (d) and (e) until the simulation results in step (e) meet the target functional parameters and constraints of step (a).

14. The method of claim 13 wherein the computational simulations in method steps (c) and (e) comprise the use of a mixed methodology model.

15. The method of claim 13 wherein the computationally simulating steps (c) and (e) comprise simulating two or more pressure-driven flow, electroosmotic flow, analyte dispersion, analyte mixing, fluid mixing, and a chemical or biochemical reaction.
